(19) United States
(12) Patent Application Publication
(10) Pub. No.: US 2026/0370247 A1
(43) Pub. Date: Nov. 19, 2026

(54) MULTI-CHANNEL RF SYSTEM-ON-A-CHIP ARCHITECTURE WITH BASELINE BIASING AND FAST RF-STATE REGISTER PIPELINES

(71) Applicant: EMTAR Technologies Inc., Richmond (CA)

(72) Inventors: Min-Yu HUANG, Richmond (CA); Peng-Fei LIN, Richmond (CA)

(73) Assignee: EMTAR Technologies Inc., Richmond (CA)

(21) Appl. No.: 19/727,865

(22) Filed: Jul. 1, 2026

Related U.S. Application Data
(63) Continuation of application No. PCT/IB2026/052108, filed on Mar. 4, 2026.
(60) Provisional application No. 63/766,986, filed on Mar. 5, 2025.

(51) Int. Cl. H04B 1/04; G06F 9/30; G06F 9/38

(52) U.S. Cl. CPC H04B 1/0458; G06F 9/30043; G06F 9/30101; G06F 9/3854

(57) ABSTRACT

The present disclosure provides various techniques for controlling multi-channel radio-frequency systems using staged register pipelines, shared memory structures, and co-designed front-end architectures. A multi-channel RF system-on-a-chip can include per-channel SRAM that stores RF state entries and RF-biasing and RF-state register pipelines. In some embodiments, first-stage registers can be incrementally written over a narrow shared bus and second-stage registers are synchronously updated in response to a fast-load control to apply new RF states in a deterministic, low-latency manner. Additional aspects include channel grouping, TX/RX-dedicated and shared pipelines, and mode controls support full-duplex FDD and half-duplex TDD operation, including analog, digital, and hybrid beamforming with independently configurable per-channel amplitude and phase. External master and edge-computing devices, optionally assisted by artificial-intelligence components, can select RF states based on feedback. Furthermore, ICs that are co-designed with different antenna implementations can use distributed impedance co-matching to optimize array performance.

### CROSS REFERENCE TO RELATED APPLICATION

This application is a continuation of International Application No. PCT/IB2026/052108, filed Mar. 4, 2026, and entitled “MULTI-CHANNEL RF SYSTEM-ON-A-CHIP ARCHITECTURE WITH BASELINE BIASING AND FAST RF-STATE REGISTER PIPELINES,” which claims the benefit of U.S. Provisional Patent Application No. 63/766,986, filed Mar. 5, 2025, and entitled “Multi-Channel RF System-on-Chip (SOC) Architecture and Applications,” which are assigned to the assignee hereof. The disclosure of the prior Applications are considered part of and are incorporated by reference in this Patent Application.

### TECHNICAL FIELD

This present disclosure relates generally to analog circuit design and, more specifically, to control of radio frequency (RF) elements in integrated circuits and wireless communication systems.

### BACKGROUND

Radio frequency (RF) systems and their applications including, e.g., sixth-generation (6G) telecommunications networks and beyond, Wi-Fi systems, satellite and non-terrestrial networks (NTN), integrated sensing and communication (ISAC), vehicle-to-everything (V2X) systems, Internet-of-Things (IoT) applications, industrial and private networks, defense and aerospace systems, and medical and wearable devices, have become an integral part of modern society.

These RF systems often rely on multi-antenna and multi-channel architectures. Phased-array antennas, massive multiple-input multiple-output base stations, satellite user terminals, and automotive radar platforms can involve tens or thousands of RF channels that are adjusted in a coordinated fashion for beamforming, spatial multiplexing, or duplex operation. In many existing solutions, each RF channel is controlled through configuration information written into on-chip registers or memory structures using serial or parallel control interfaces. As channel counts and supported operating modes grow, these traditional control schemes can become difficult to scale, and the amount of configuration traffic needed to update RF states across many channels can increase significantly, which can contribute to higher latency and become a barrier to high-speed operations.

Moreover, control information for multi-channel RF devices often includes different elements, some relatively stable (e.g., calibration and bias conditions) while some others more frequently updated (e.g., settings associated with particular beams, frequency bands, or transmit and receive roles). Even where such elements are distinguished at a logical or register level, managing different types of information over shared control interfaces and within common control frameworks can add complexity for control logic and firmware. In certain conventional architectures, at least some configuration updates are applied as soon as new values are written, so different channels or sub-functions can observe new settings at different times, which can make it more challenging to coordinate changes across large numbers of channels, particularly when fast transitions between receive and transmit roles, or between different beam patterns, are desired.

In addition, distribution of this control information inside multi-channel RF devices can present practical design challenges. In some implementations, per-channel dedicated control lines from a central controller increase routing density and coupling within the integrated circuit. In other implementations, shared-bus approaches reduce the number of wires but can be constrained by generic addressing schemes that are not well aligned with RF-channel groupings or duplex roles, and group updates can require repeated transmission of similar information to different channels. As a result, control of channel groupings, full-duplex and half-duplex behavior, and beam-management strategies is often handled largely in firmware, which can increase software complexity and can make timing behavior less deterministic as system bandwidth and channel count grow.

Accordingly, there is a need for improved control architectures for multi-channel RF system-on-a-chip devices that better support scalable configuration of many RF channels, more predictable timing behavior, and more consistent operation across varying operating conditions.

### BRIEF DESCRIPTION OF THE DRAWINGS

One or more embodiments of the present disclosure are illustrated by way of example, and not by limitation, in the figures of the accompanying drawings, in which like references indicate similar elements. These drawings are not necessarily drawn to scale.

FIG. 1 illustrates an example system-level functional block diagram in which a master device provides control signaling to a destination system-on-a-chip (SoC) that is configured to implement one or more techniques disclosed here.

FIG. 2 illustrates an example system including a multi-channel radio-frequency (RF) SoC that is controlled by a master device and can cooperate with artificial-intelligence (AI) or edge-computing functions.

FIG. 3 illustrates an example SoC architecture showing certain implementation details in an embodiment of the SoC introduced in FIG. 1.

FIG. 4 illustrates an example per-channel organization in which a channel-specific SRAM stores multiple RF state entries for a corresponding single-channel RF processing chain.

FIG. 5 illustrates an example digital-control and register-pipeline architecture in which multiple components cooperate to configure multiple single-channel RF processing blocks associated with respective RF channel ports.

FIG. 6 illustrates an example shared-bus architecture in which a routing bus is coupled to multiple channel SRAMs and another routing bus is coupled to multiple channel-specific register-biasing circuits.

FIG. 7A illustrates example receive-only and transmit-only RF paths, each having cascaded functional blocks that are driven by RF-state registers and RF-biasing registers so as to enable full-duplex operations for analog beamforming.

FIG. 7B illustrates another example RF front-end in which separate transmit and receive paths can share downstream application circuitry through switching circuitry and be controlled by respective RF-state registers and RF-biasing registers so as to enable half-duplex operations for analog beamforming.

FIG. 8 illustrates an example channel-grouping and register-pipeline architecture in which channel SRAMs can be grouped and accessed independently, thereby supporting full-duplex frequency-division-duplex (FDD) multi-channel operation.

FIG. 9 illustrates another example channel-grouping and register-pipeline architecture in which SRAMs can be grouped into different channels in combination with separate transmit-path and receive-path control, thereby supporting half-duplex time-division-duplex (TDD) multi-channel operation.

FIG. 10 illustrates an example multi-byte write mechanism in which a narrow write-data bus and associated switching circuitry can be used to load a wider RF-state register word into first-stage registers.

FIG. 11A illustrates example baseband architecture having receive-only and transmit-only processing chains to support full-duplex operations for digital or hybrid beamforming.

FIG. 11B illustrates another example baseband architecture in which a shared front-end with switching circuitry feeds separate receive and transmit processing chains to support half-duplex operations for digital or hybrid beamforming.

FIG. 12 illustrates an example in which a multi-channel RF SoC operates as a beamforming integrated circuit (IC), with multiple single-channel beamforming chains coupled to an antenna array and configured by a master device and optional AI processing.

FIG. 13 illustrates an example deployment including multiple N-channel RF SoCs forming a scalable RF SoC group having multi-mode, multiple-antenna-array processing capability for wireless communication.

FIG. 14 illustrates an example co-design scenario in which an IC (e.g., an SoC) is coupled to an antenna formed in a printed-circuit board (PCB).

FIG. 15 illustrates another example co-design scenario in which an IC is coupled to an antenna with an antenna-in-package (AiP) configuration

FIG. 16 illustrates still another example co-design scenario in which an IC is wire-bonded through PCB routing and vias to an antenna implemented in the PCB.

FIG. 17 illustrates yet another co-design scenario in which an IC is wire-bonded to a PCB that carries an antenna that is also wire-bonded to the PCB.

### DETAILED DESCRIPTION

In a number of emerging wireless communication, radar, and sensing use cases, system requirements are trending toward architectures that call for an increasing number of coordinated radio-frequency (RF) channels to achieve higher data rates, wider bandwidths, and more agile spatial control. A single device can be expected to support multiple frequency bands, different duplex schemes, and a variety of beam patterns or operating modes, often under tight timing constraints. Further, as these capabilities expand, the underlying radio-frequency control architecture is increasingly expected to manage a growing volume of configuration information for a large number of RF signal paths, while still fitting within realistic silicon area, power, and routing budgets on an integrated circuit (IC).

As described above, multi-channel RF systems used in applications such as phased-array communication, radar, and sensing can involve many RF channels that need to be configured and reconfigured in a coordinated manner. In a number of existing solutions, configuration information is delivered through control schemes and register structures that can be difficult to scale as channel counts and supported operating modes increase. Conventionally, control information that changes on different time scales may be managed through common control flows, configuration updates for different channels may take effect at different times, and routing of configuration signals may introduce additional complexity when many RF channels are present. These characteristics can make it harder to support high-speed operations, coordinated duplex behavior, and flexible channel grouping in large multi-channel RF system-on-a-chip (SoC) devices.

Introduced here, therefore, are techniques that can be used to implement multi-channel RF SoC architectures in which RF state information and baseline biasing information are addressable and managed through staged register pipelines and channel-specific memory, and in which configuration traffic is distributed over shared routing structures using per-channel identifiers and channel grouping. In some examples, per-channel static random access memory (SRAM) stores multiple RF state entries for each RF processing chain, and a two-stage RF-state register pipeline is used to separate preparation of a new state from application of that state using a fast-load control that can support more predictable timing and more coordinated application of RF configuration across multiple channels. In some embodiments, a corresponding RF-biasing register pipeline can be used to establish and adjust baseline operating conditions. A routing fabric can also provide shared access paths to per-channel memories and registers using identifiers so that commands can address individual channels, groups of channels, or channel roles associated with duplex modes. In addition, the multi-channel RF SoC can be co-designed with front-end ICs and antenna structures so that RF control and impedance-matching behavior are coordinated.

Overall, the embodiments of the present disclosure can support scalable configuration of many RF channels, more predictable timing of configuration changes, and more flexible channel grouping for full-duplex and half-duplex operation. By using staged register pipelines and a fast-load mechanism, the disclosed architectures can allow RF state information to be prepared in advance and then applied to multiple RF processing circuits in a coordinated manner, which can help reduce transient inconsistencies during reconfiguration. Shared routing structures with channel identifiers can reduce routing density compared to fully dedicated per-channel control lines, while still enabling targeted or broadcast updates to selected channels or channel groups. Co-design of the multi-channel RF SoC with associated front-end ICs and antennas can further support consistent operation across different operating environments and system configurations.

Moreover, the disclosed control architectures can be integrated into broader system contexts that include master controllers, edge-computing resources, and artificial intelligence (AI) based optimization engines. For example, external or on-chip processing units can observe performance metrics from the RF system, select or refine RF state entries for different channel groups, and then coordinate fast-load updates across the register pipelines so that new states are activated in a synchronized manner. In multi-chip deployments in which several multi-channel RF SoCs cooperate to drive larger antenna arrays, the same staged and identifier-based control mechanisms can help align configuration changes across chips while limiting additional routing and interface complexity, which can facilitate scaling to higher channel counts and more demanding wireless scenarios.

In the following, numerous specific details are set forth to provide a thorough understanding of the presently disclosed techniques. In other embodiments, the techniques introduced here can be practiced without these specific details. In other instances, well-known features, such as specific fabrication techniques, are not described in detail in order to avoid unnecessarily obscuring the present disclosure. References in this description to “an embodiment,” “one embodiment,” or the like, mean that a particular feature, structure, material, or characteristic being described is included in at least one embodiment of the present disclosure. Thus, the appearances of such phrases in this specification do not necessarily all refer to the same embodiment. On the other hand, such references are not necessarily mutually exclusive either. Furthermore, the particular features, structures, materials, or characteristics can be combined in any suitable manner in one or more embodiments. Also, it is to be understood that the various embodiments shown in the figures are merely illustrative representations and are not necessarily drawn to scale.

Certain details relating to structures or processes commonly associated with the integrated circuit design, including physical layouts of typical passive components, e.g., inductors, capacitors, resistors, filters, and related subcomponents, may not be set forth in the following description, as inclusion of such well-known details could obscure significant aspects of the disclosed techniques. Moreover, although the following disclosure sets forth several embodiments of different aspects of the present disclosure, several other embodiments can have different configurations or different components than those described in this section. Accordingly, the introduced techniques can have other embodiments with additional elements or without several of the elements described below.

For purposes of discussion here, the terms “coupled” and “connected,” along with their derivatives, can be used to describe structural relationships between components. It should be understood that these terms are not intended as synonyms for each other. Rather, in particular embodiments, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements co-operate or interact with each other (e.g., as in a cause and effect relationship), or both. Notwithstanding the above, and unless otherwise specified or made clear by the context, references to components being “connected in series” or “connected in parallel” refer to their functional electrical relationship rather than requiring uninterrupted physical conductors.

For purposes of discussion here, an “upstream” device refers to a device that is positioned earlier in a daisy-chain command-distribution path than one or more “downstream” devices, with “upstream” and “downstream” describing relative positions in the chain rather than any particular upload or download operation.

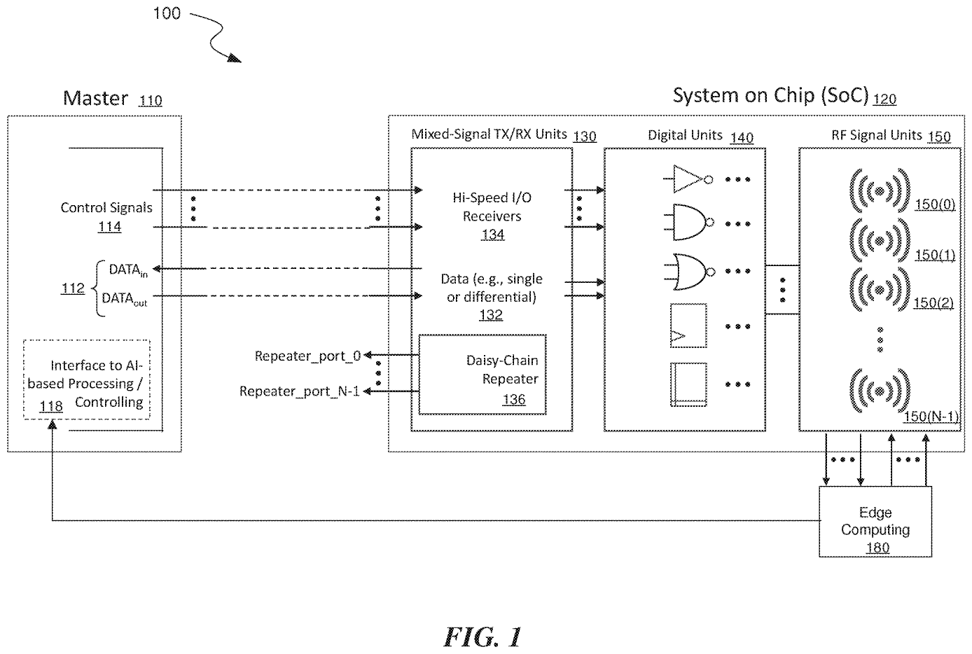

FIG. 1 illustrates an example functional block diagram of a system 100 in which a master device 110 provides command data and control signaling to a system-on-a-chip (SoC) 120 that implements one or more techniques disclosed here. In some examples, the master device 110 is implemented as a controller device or system configured to provide data and control signals to one or more integrated circuits (ICs) and/or subsystems. For example, the master device 110 can include a personal computer (PC), a field-programmable gate array (FPGA), an embedded processor, test equipment, or another suitable computing or controlling apparatus. In a number of embodiments, the master device 110 sends commands and configuration information that is destinated to the SoC 120 and, in some examples, can also receive status information or readback information from the SoC 120. The master device 110 can communicate using a serial command interface 112 that includes a data input path (DATA_in) and a data output path (DATA_out). The master device 110 can also provide one or more control signals 114 that establish, e.g., timing, framing, enablement, and/or transaction boundaries for the data interface 112. One or more auxiliary signals can also be present between the master device 110 and the SoC 120 including, e.g., power, ground, reset, clock, enable, selection signals, mode signals, status signals, and/or handshaking signals. In some implementations, the SoC 120 can further include one or more separate interfaces for user payload traffic, which are not illustrated in FIG. 1 for simplicity.

The SoC 120 can be an IC that includes mixed-signal transmitter/receiver (TX/RX) units 130, one or more digital units 140, and radio-frequency (RF) signal units 150. The mixed-signal TX/RX units 130 include circuitry configured to transmit and/or receive signals and can include both analog and digital circuitry. In the illustrated example, the mixed-signal TX/RX units 130 include data circuitry 132 configured to receive and/or transmit command and configuration data on the data interface 112, where the signals can be single-ended or differential in various examples. The mixed-signal TX/RX units 130 also include high-speed input/output receivers 134 configured to receive incoming command data on the DATA_in path together with associated control signaling 114 and provide corresponding signals to the digital units 140. The digital units 140 can include circuitry comprising at least one of combinational logic, sequential logic (e.g., flip-flops or latches), memory elements (e.g., static random access memory (SRAM)), processing cores, state machines, or any combination thereof. In some embodiments, the digital units 140 can interpret commands and associated data received from the master device 110 and, in response, generate configuration information that controls operation of the RF signal units 150.

The RF signal units 150 include multiple RF signal paths 150(0) through 150(N−1) that can correspond to transmit paths, receive paths, or other RF processing circuits associated with a multi-channel RF subsystem. In a number of embodiments, the digital units 140 can control configuration information for the RF signal paths 150(0) through 150(N−1), e.g., by accessing and programming channel-specific memory that stores RF state entries and by loading control information into register circuitry that applies configuration settings to the RF signal units 150, as described in greater detail below with reference to subsequent figures. In some embodiments, the digital units 140 also manage baseline biasing information that is applied to the RF signal units 150, e.g., by maintaining baseline biasing information in one or more biasing register structures that provide bias control information to the RF signal units 150. In addition, the SoC 120 can support readback or reporting, e.g., by providing status information or retrieved configuration values back to the master device 110 using the DATA_out path or another suitable reporting path.

In some embodiments, the mixed-signal TX/RX units 130 further include a daisy-chain repeater 136 that supports a cascaded command path to downstream devices. For example, the daisy-chain repeater 136 can receive a serial command data stream from the high-speed input/output receivers 134 and can forward a version of that stream through one or more repeater ports, such as Repeater_port_0 through Repeater_port_N−1, so that additional downstream devices can be coupled in a chain. This arrangement can allow the master device 110 to distribute command data across multiple SoCs while reducing the number of separate high-speed interfaces that are routed from the master device 110. In some examples, the SoC 120 can selectively enable or disable the daisy-chain repeater 136 based on whether a downstream device is present.

In one or more embodiments, the SoC 120 can cooperate with an edge-computing node 180 and, in such optional embodiments, the master device 110 can include an interface 118 to support artificial intelligence (AI) based processing or control functions. In some examples, the edge-computing node 180 can be a computing entity located at or near a data source and configured to perform at least a portion of data processing, analysis, decision-making, and/or control generation locally. In an example operational flow, the edge-computing node 180 can generate and transmit one or more commands to the master device 110 and/or an AI processing component via the interface 118, where the commands can specify control objectives and/or constraints such as target waveform characteristics, frequency selection, power level, timing requirements, temperature reading, wafer corner readout, or configuration states. In response, the master device 110 and/or the AI processing component can determine and issue corresponding control signals 114 and associated serial command data so that the SoC 120 configures one or more RF signal units 150 to generate one or more signals desired by the edge-computing node 180. The edge-computing node 180 can evaluate resulting signals and provide updated commands based on observed performance, thereby forming a closed-loop feedback mechanism that enables at least a partial level of automated and adaptive control.

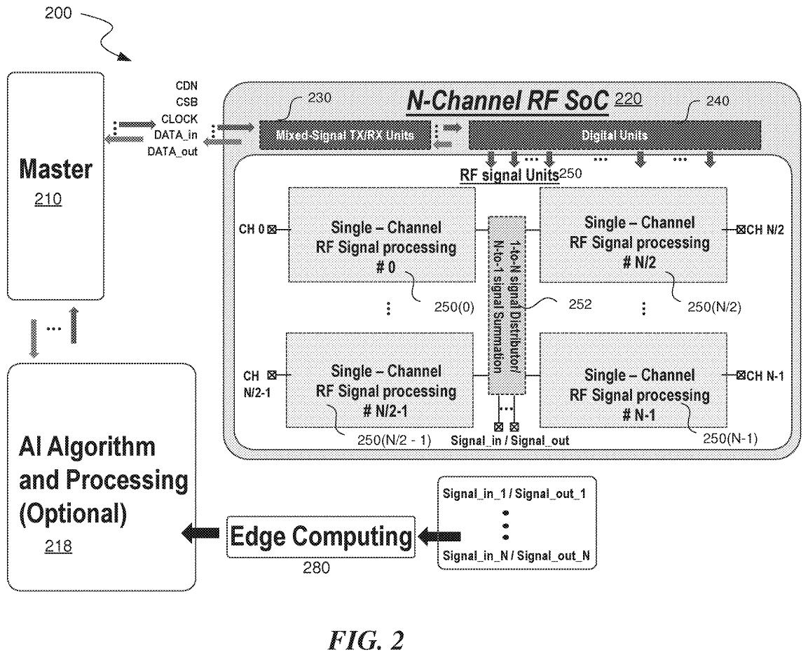

FIG. 2 illustrates an example system 200 including an N-channel radio-frequency (RF) system-on-a-chip (SoC) 220 that is controlled by a master device 210 and that can cooperate with artificial-intelligence (AI) and edge-computing functions. The master device 210 communicates with the N-channel RF SoC 220 over a high-speed interface that carries a serial command data stream (DATA_in/DATA_out) together with associated control signaling such as a clock (CLK), a clock disable signal (CDN), and a chip-select signal (CSB). Through this interface, the master device 210 can send configuration commands and RF state information toward the N-channel RF SoC 220 and, in some embodiments, receive readback information that reflects internal configuration or measurement results.

More specifically, the N-channel RF SoC 220 includes mixed-signal transmitter/receiver (TX/RX) units 230, digital units 240, and RF signal units 250. The mixed-signal TX/RX units 230 can, e.g., receive the DATA_in stream and related control signals from the master device 210, perform clock and data recovery, and deliver deserialized command and data signals to the digital units 240. The digital units 240 can, e.g., implement control logic, memory arrays, and state machines that decode commands from the master device 210 and generate configuration information for the RF signal units 250. In some embodiments, the digital units 240 can include one or more static random access memory (SRAM) arrays that provide memory capacity sufficient to store multiple RF signal states for each RF channel. Each RF signal state can include one or more control parameters including, e.g., amplitude, phase, gain, frequency, timing, and other signal-control settings used to operate a corresponding RF signal path within the RF signal units 250.

The RF signal units 250 implement N single-channel RF signal processing chains 250(0) through 250(N−1). Each single-channel RF signal processing chain 250(i) can include one or more configurable RF blocks such as low noise amplifier, power amplifier, variable gain amplifiers, phase shifters, mixers, attenuators, passive networks, filters, and/or analog-to-digital converter (ADC), digital-to-analog converter (DAC), equalizer, phase/amplitude complex weighting that are controlled by RF state information supplied from the digital units 240. The RF signal units 250 are coupled to a signal interface block 252. In some embodiments, the signal interface block 252 can include a 1-to-N signal distributor configured to route an input signal or input data stream (e.g., one or more signals collectively indicated as Signal_in_1 through Signal_in_N) to a selected subset of the single-channel RF signal processing chains 250(0) through 250(N−1) and to provide channel-specific routing for parallel operation. The signal interface block 252 can also include N-to-1 signal summation circuitry configured to aggregate, combine, select, or summarize outputs from the single-channel RF signal processing chains 250(0) through 250(N−1) to form a consolidated output signal (which, in different implementations, can be represented as one or more output signals, e.g., Signal_out_1 through Signal_out_N). The consolidated output signal can then be provided to an edge-computing node 280. In one or more examples, the signal can be in the format of RF, intermediate frequency (IF), and/or digital signals.

The edge-computing node 280 can be a computing entity located at or near a data source and configured to perform at least a portion of data processing, analysis, decision-making, and control generation locally. In one or more embodiments, the edge-computing node 280 can analyze the consolidated output signal from the N-channel RF SoC 220 to evaluate performance metrics, channel conditions, beam patterns, or other system behaviors. Based on this analysis, the edge-computing node 280 can generate higher-level commands or objectives that are sent toward the master device 210 and, in some embodiments, toward an AI algorithm and processing component 218. The AI algorithm and processing component 218 can be implemented as a separate processing block coupled to the master device 210 or integrated within the master device 210 itself. The AI algorithm and processing component 218 can use feedback from the edge-computing node 280, together with historical state information and system constraints, to compute updated RF state selections, suggested parameter values, or channel-grouping strategies.

In a number of implementations, the digital units 240 support not only downstream configuration but also upstream readback through the DATA_out portion of the interface. For example, the N-channel RF SoC 220 can output, via the DATA_out path, readout information corresponding to an SRAM address or selection value used to choose a stored RF signal state, as well as control data associated with the selected RF signal state. The readout information can be provided to the master device 210 for verification or logging. When rapid or dynamic response is desired, the master device 210 can also forward at least a portion of the readout information to the AI algorithm and processing component 218. The AI algorithm and processing component 218 can then generate an estimated or optimized response and provide feedback to the master device 210.

Responsive to commands or recommendations from the edge-computing node 280 and/or the AI algorithm and processing component 218, the master device 210 can generate corresponding DATA_in signaling that instructs the digital units 240 to select particular RF signal states from the SRAM arrays, to write updated RF signal states, or to trigger application of staged states to the RF signal units 250. In this manner, the system 200 can support multiple feedback loops that link the N-channel RF SoC 220, the master device 210, the AI algorithm and processing component 218, and the edge-computing node 280. These feedback loops can also enable automated and adaptive reconfiguration of the single-channel RF signal processing chains 250(0) through 250(N−1) in response to dynamically changing wireless-channel conditions or application requirements.

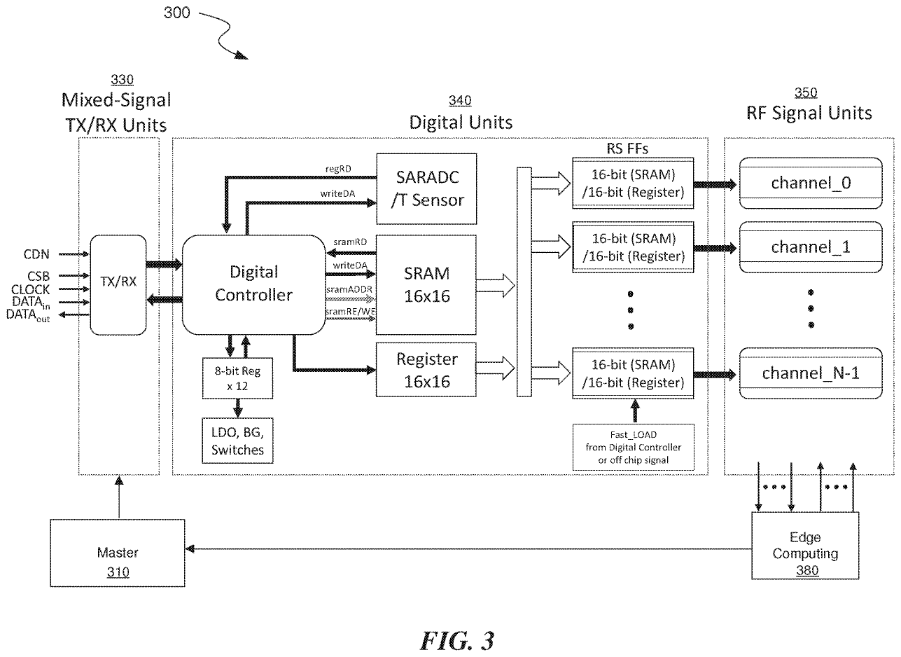

FIG. 3 illustrates an example system-on-a-chip (SoC) architecture 300 showing certain implementation details in one embodiment of the SoC 120 introduced in FIG. 1. The SoC architecture 300 is partitioned into mixed-signal transmitter/receiver (TX/RX) units 330, digital units 340, and radio-frequency (RF) signal units 350. A master device 310 provides a downstream serial command data stream (DATA_in), an upstream readback data stream (DATA_out), and associated control signaling (e.g., CDN, CSB, CLOCK) to the mixed-signal TX/RX units 330, which in turn interface with the digital units 340. The RF signal units 350 implement per-channel RF paths whose operating parameters are controlled based on configuration information stored and processed in the digital units 340. In some embodiments, one or more outputs of the RF signal units 350 are further coupled to an edge-computing node 380, which can perform local processing and feedback generation as described above in connection with FIG. 2.

In the illustrated embodiment, the mixed-signal TX/RX units 330 include a TX/RX block that receives the CLOCK signal, the chip-select signal CSB, and the serial DATA_in and DATA_out signals from the master device 310. In one or more examples, the DATA_in signal carries a serial command stream that encodes device-level and channel-level configuration information in a defined field structure, while the DATA_out signal can be used to convey readback information or other upstream data from the SoC architecture 300 to the master device 310. The TX/RX block can, e.g., deserialize the incoming command stream using the CLOCK signal provided by the master device 310 and can forward corresponding clock and data signals to a digital controller within the digital units 340. In some examples, the TX/RX block includes clock-recovery or clock-conditioning circuitry, such as a phase-locked loop (PLL), to regenerate or clean a sampling clock from the received signaling. Additional signals such as the reset signal CDN and other bias or reference signals can also be provided to the mixed-signal TX/RX units 330.

The digital units 340 include a digital controller that receives the deserialized serial command stream from the mixed-signal TX/RX units 330 and interprets the commands and configuration fields contained in that stream. Based on the decoded commands, the digital controller can generate internal control signals and memory-access signals to update configuration storage for the RF signal units 350. The digital units 340 can further include a successive-approximation-register analog-to-digital converter and temperature sensor block (SARADC/T sensor), an SRAM array (SRAM 16×16), and a register array (Register 16×16). The SARADC/T sensor block can monitor on-chip operating conditions, such as supply voltage or die temperature, and can provide corresponding digital readings to the digital controller, which can in turn adjust configuration settings or bias conditions in response. The SRAM 16×16 and the Register 16×16 can together form part of the memory circuitry that stores RF configuration information for the RF signal units 350.

In accordance with a number of examples, the SRAM 16×16 can be arranged as 16 rows by 16 columns, where each row corresponds to a particular channel or RF path and each column corresponds to a bit position in a multi-bit configuration word. The digital controller can write configuration words into selected rows of the SRAM 16×16 based on channel identifiers and memory addresses parsed from the command stream, thereby building up sets of RF signal states for multiple channels. These RF signal states can include, e.g., amplitude settings, phase-control values, frequency-state bits, timing parameters, and other channel-specific control fields. The Register 16×16 can be used to store global or block-level configuration information, calibration coefficients, or other control parameters that are not strictly per-channel but that are nevertheless programmed and read using the same command stream. In some embodiments, the digital controller can access the SRAM 16×16 and the Register 16×16 using shared address, data, and control lines, while internal decoding logic determines which storage elements respond to a particular transaction.

Further included in the digital units 340, and coupled to the RF signal units 350, is a bank of storage elements in the form of reset-set flip flops (RS FFs) that can provide storage space for per-channel output. In the illustrated embodiment, each per-channel storage stage includes, e.g., a 16-bit storage portion that receives configuration data from the SRAM 16×16 and a 16-bit storage portion that receives configuration data from the Register 16×16. These storage elements can operate as active-state registers that directly drive control inputs of the RF signal units 350. Configuration information accumulated in the SRAM 16×16 and the Register 16×16 can be, e.g., first staged in intermediate storage within the digital controller, and then loaded into the RS FFs under control of the digital controller, so that pending RF configuration values become active in a coordinated fashion across the RF signal units 350. A fast-load control (Fast_LOAD) can be asserted by the digital controller or, in certain embodiments, driven by an external device via a dedicated input, to trigger transfer of stored configuration words into the RS FFs and thereby update the RF operating state of multiple channels substantially simultaneously.

The RF signal units 350 can be implemented as a set of channel-indexed RF ports, including a channel_0 port, a channel_1 port, and a channel_(N−1) port, each port corresponding to an RF signal unit. Each RF signal unit 350(i) can correspond to a transmit chain, a receive chain, a phase-shifter path, a gain stage, or another RF front-end element associated with an antenna array or a multi-channel RF subsystem. In various implementations, the control inputs of each RF signal unit 350(i) can be driven by the active configuration bits stored in the corresponding RS FFs, which represent the current RF configuration selected for that channel. Furthermore, in some embodiments, the outputs from the RF signal units 350 can be provided to the edge-computing node 380, which can analyze resulting RF waveforms or measurements and feed back updated objectives or commands toward the master device 310, as described previously. In this way, the SoC architecture 300 provides a concrete example of how mixed-signal interface circuitry, digital control logic, staged memory structures, and per-channel RF paths can be integrated on a single chip to support scalable and reconfigurable multi-channel RF operation.

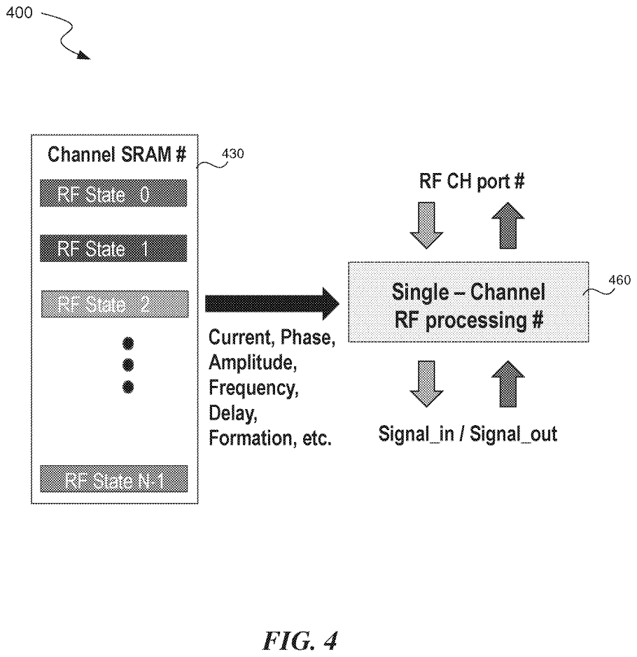

FIG. 4 illustrates an example per-channel organization 400 in which a channel-specific static random access memory (SRAM) 430 can store multiple radio-frequency (RF) state entries for a corresponding single-channel RF processing block 460. For clarity, FIG. 4 depicts one representative RF channel; in practice, a multi-channel RF system can include many instances of the channel-specific SRAM 430 and the single-channel RF processing block 460, each associated with a different RF channel port.

As shown in FIG. 4, the channel-specific SRAM 430 can hold a plurality of RF state entries, e.g., RF State 0, RF State 1, RF State 2, through RF State N−1. Each RF state entry represents a stored configuration snapshot for the single-channel RF processing block 460. An RF state entry can include digital control fields that specify one or more parameters such as amplitude, phase, power, operating frequency, timing or delay, waveform-shape descriptors, and beamforming or precoding characteristics, together with other RF signal attributes for that channel. In some examples, the master device can initially write a plurality of RF state entries into the channel-specific SRAM 430 and thereafter selects among the stored RF state entries by issuing commands that reference the desired entry. In such examples, these RF state entries thus can provide a library of pre-defined RF signal states that can be selected or recalled using compact commands, without re-transmitting all underlying parameter values from a master device. The RF signal states can also be updated afterwards or replaced with the pre-defined states.

Upon receiving a command that identifies a selected RF state stored in the channel-specific SRAM 430, control logic in the digital units (not shown in FIG. 4) can cause the single-channel RF processing block 460 to configure itself according to the selected RF state. In some embodiments, the single-channel RF processing block 460 is configured, responsive to the command, to modify one or more signal characteristics and/or to generate downstream control instructions associated with the selected RF state. For example, in a transmitter mode, the single-channel RF processing block 460 can condition a signal propagated from a Signal_in interface toward an RF channel port associated with that channel. As another example, in a receiver mode, the single-channel RF processing block 460 can condition a signal propagated from the RF channel port toward a Signal_out interface. The Signal_in and Signal_out interfaces can be represented in one or more domains including digital, analog, intermediate-frequency (IF), and radio-frequency formats, depending on where the single-channel RF processing block 460 resides within a larger transmit or receive chain.

In typical operation, higher-level control circuitry in the SoC can first select an RF state entry in the channel-specific SRAM 430 using, e.g., a combination of channel identification and state index information carried in a command stream. The selected RF state entry is then transferred from the channel-specific SRAM 430 into RF-state register stages, as described in later figures, and subsequently applied to control points within the single-channel RF processing block 460. Because the RF state entries are pre-stored per channel and can be recalled by compact commands, the architecture shown in FIG. 4 can enable rapid switching among many complex RF operating states while limiting configuration traffic and preserving deterministic behavior at the RF channel port.

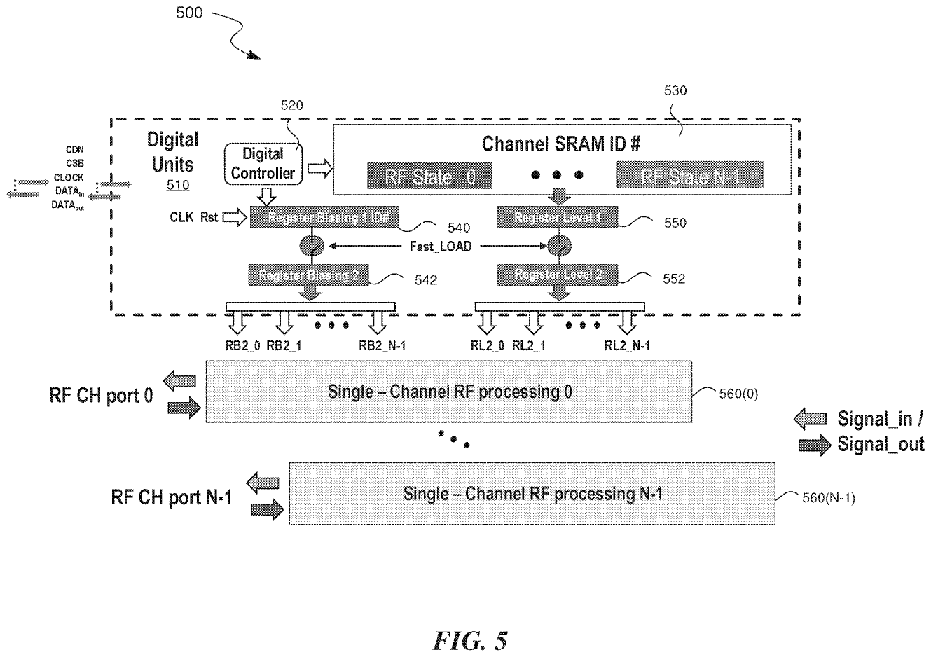

FIG. 5 illustrates an example digital-control and register-pipeline architecture 500 in which digital units 510 cooperate with per-channel channel static random access memory (SRAM), biasing-register pipelines, and RF-state register pipelines to control a plurality of single-channel RF processing blocks 560(0) through 560(N−1). As shown in FIG. 5, the architecture 500 can implement N representative RF channels, e.g., RF channel port 0 and an RF channel port N−1; in practice, the architecture 500 can be adopted for any desired number of channels.

The digital units 510 can include a digital controller 520 that receives the downstream serial command data stream DATA_in, the upstream readback stream DATA_out, and associated control signaling such as the clock signal CLOCK, the reset signal CDN, and the chip-select signal CSB, as described previously with respect to FIGS. 1-3. In one or more embodiments, the digital controller 520 decodes commands carried in the DATA_in stream, including, e.g., channel identifiers, RF-state indices, and bias-configuration commands, and generates internal control signals and memory-access signals for the remaining circuitry within the digital units 510. In some implementations, the digital units 510 can interface to one or more on-chip read-only memory (ROM) structures that can store baseline bias values and, in certain examples, identifier (ID) information for channel-specific blocks such as channel SRAM circuits and biasing-register circuits. In a number of embodiments, these identifiers can be implemented using metal-programmable ROM bits so that ID values can be adjusted by changing a metal mask without redesigning underlying logic.

According to the present embodiments, a channel SRAM block 530 that is implemented in the digital units 510 can be organized on a per-channel basis, each channel SRAM being associated with a channel SRAM identifier (ID). In at least some embodiments, the channel SRAM identifier can be determined at design time and recorded in, e.g., on-chip ROM. In some embodiments, the on-chip ROM can be implemented as a mask ROM whose contents are fixed during fabrication using metal-mask options, enabling different product variants. In other embodiments, other types of ROM may be implemented. For a given channel, the channel SRAM block 530 stores multiple RF state entries, such as RF State 0, RF State 1, . . . , to RF State N−1, each of which represents a configuration snapshot for the RF signal path associated with that channel. As described in connection with FIG. 4, each RF state entry can include digital control fields for amplitude, phase, power, operating frequency, timing or delay, waveform shape, beamforming or precoding characteristics, and/or other RF signal attributes. In a number of embodiments, the digital controller 520 can issue read and write accesses to the channel SRAM block 530 based on channel identifiers and RF-state indices decoded from the command stream, so that appropriate RF state information can be retrieved for staging and application. Because each channel SRAM in the channel SRAM block 530 can have its own identifier, each channel SRAM can be individually selected when shared address, data, and control signaling is broadcast over a common routing fabric or bus, as further described with reference to later figures.

On the biasing side, the digital units 510 include a first-stage biasing register block 540 (Register Biasing 1) and a second-stage biasing register block 542 (Register Biasing 2). At chip start-up, e.g., after completion of a clock-reset sequence, the digital controller 520 can load baseline bias values from the on-chip ROM into selected locations within the first-stage biasing register block 540 for each of the N channels. In some embodiments, the first-stage biasing register block 540 can be organized so that each channel has an associated bias-register identifier (ID). The bias-register identifiers can likewise be stored in ROM and, in certain designs, implemented using metal-programmable options. The bias-register identifiers can be used together with channel SRAM identifiers on a shared routing fabric so that bias registers and channel SRAMs share a common access bus yet remain individually addressable. These baseline values can correspond, e.g., to default operating points for bias currents, bias voltages, or enable signals that are tailored to a particular product variant. The configuration values stored in the first-stage biasing register block 540 can be chosen so that the analog and RF building blocks in each single-channel RF processing block 560(i) operate at specified nominal performance targets, such as desired gain, linearity, and power consumption. It is noted that, in these examples, baseline biasing information maintained in the first-stage and second-stage biasing register blocks 540 and 542 is separate from the control information of the RF state entries stored in the channel SRAM block 530 and the RF-state register blocks 550 and 552.

After Register Biasing 1 has been initialized, the digital controller 520 can cause the baseline bias values in the first-stage biasing register block 540 to be propagated into the second-stage biasing register block 542, e.g., by asserting a fast-load control signal or by issuing an internal bias-load command. The second-stage biasing register block 542 then drives per-channel bias outputs RB2_0 through RB2_N−1 toward the corresponding single-channel RF processing blocks 560(0) through 560(N−1). In this manner, the biasing-register pipeline establishes initial operating conditions and/or initial operating modes for each RF channel. Further, in one or more implementations, during a calibration or fine-tuning phase, the digital controller 520 can override the ROM-derived baseline values by receiving updated bias settings from the master device and writing those settings into selected locations of the first-stage biasing register block 540. After the updated bias values are written, the digital controller 520 can again assert the fast-load control so that the second-stage biasing register block 542 is refreshed with the new values, thereby applying calibrated bias conditions to the RF channels. This two-stage organization, with a first-stage biasing register block 540 that is writable and a second-stage biasing register block 542 that directly drives the RF circuitry, allows the system to compensate for wafer-level and die-level process variations and to reduce channel-to-channel variation by aligning operating conditions across the N channels. In some embodiments, the baseline bias values are used to establish nominal operating points for the RF processing blocks 560(0) through 560(N−1) before RF state information is committed from the first-stage RF-state register block 550 to the second-stage RF-state register block 552. Once calibration is complete and the desired operating conditions have been established, the bias values in the first-stage biasing register block 540 can remain unchanged during normal operation, so subsequent fast-load events that update RF-state information do not disturb the established baseline bias conditions in the second-stage biasing register block 542.

On the RF-state side, the digital units 510 include a first-stage RF-state register block 550 (Register Level 1) and a second-stage RF-state register block 552 (Register Level 2). When the master device instructs the SoC to apply a particular RF state, the digital controller 520 can issue an access to the channel SRAM block 530 to read out the corresponding RF state entry for the addressed channel. The retrieved configuration word or words are then loaded into appropriate locations within the first-stage RF-state register block 550. In some embodiments, multiple RF state entries can be loaded into different portions of the first-stage RF-state register block 550 for different channels while previously applied RF states continue to be held in the second-stage RF-state register block 552.

In accordance with a variety of implementations, a fast-load control signal can govern when the RF state information staged in the first-stage RF-state register block 550 gets transferred into the second-stage RF-state register block 552. In the example of FIG. 5, the fast-load control is depicted as an input to the transfer path between the first-stage RF-state register block 550 and the second-stage RF-state register block 552. In certain examples, the fast-load control can be provided as a control signal separate from the DATA_in command stream, e.g., as a dedicated external pin or as an internal control line driven by the digital controller 520. The fast-load control can therefore determine whether RF state information residing in the first-stage RF-state register block 550 is held in a wait state (for later activation) or is immediately committed to the second-stage RF-state register block 552 to enable a rapid response. Further, the first-stage RF-state register block 550 can be updated with new control information while the second-stage RF-state register block 552 continues to provide previously applied control to at least one of the single-channel RF processing blocks 560(0) through 560(N−1). When the fast-load control is asserted, the contents of the first-stage RF-state register block 550 are transferred to the second-stage RF-state register block 552 substantially simultaneously for the channels involved, and the second-stage RF-state register block 552 presents updated per-channel control outputs RL2_0 through RL2_N−1 to the RF signal units 350.

In one or more embodiments, each single-channel RF processing block 560(0) through 560(N−1) is associated with a corresponding RF channel port (e.g., RF CH port 0 through RF CH port N−1). This architecture 500 implements a configurable RF path whose operating characteristics are governed by the contents of the RF-biasing registers RB2_0 through RB2_(N−1) and the RF-state registers RL2_0 through RL2_(N−1). When baseline biasing values are committed into the RF-biasing registers RB2_0 through RB2_(N−1) and RF state information is committed into the RF-state registers RL2_0 through RL2_(N−1), each single-channel RF processing block 560(i) adjusts parameters such as gain, phase, and operating mode for the associated RF channel port so that a desired RF signal state is established on that port. In addition, the single-channel RF processing blocks 560(0) through 560(N−1) can be coupled to Signal_in/Signal_out interfaces which, similar to the signal-interface arrangement described above with reference to FIG. 2, can be realized using a 1-to-N signal distributor and an N-to-1 signal summation circuit. In such examples, the 1-to-N signal distributor can route an input signal or input data stream toward selected ones of the single-channel RF processing blocks 560(0) through 560(N−1), and the N-to-1 signal summation circuit can aggregate, combine, or select outputs from the single-channel RF processing blocks 560(0) through 560(N−1) to form a consolidated output signal that is forwarded toward, e.g., an edge-computing node.

It is noted here that, because the channel SRAM block 530 and the first-stage biasing register block 540 can each have their own identifiers and can be selected independently on a shared routing fabric, the digital controller 520 is not necessarily constrained to operate all RF channels in lockstep. For example, in certain calibration flows, the digital controller 520 can use the identifiers to address only a subset of channel SRAMs and biasing registers over a common bus, turning on and calibrating one or a few single-channel RF processing blocks 560(i) while leaving other channels disabled or in a low-power state. Even further, during normal operation, the same identifier-based addressing can be used to activate only a selected group of RF channels for a given beam pattern or service, or to bring particular RF channels online earlier than others in an ad hoc fashion. This selective per-channel control, enabled by the combination of unique identifiers and shared-bus access, can allow operating modes that might otherwise be difficult to realize in architectures where all channels share common control lines without independent addressing.

Taken together, the architecture 500 of FIG. 5 shows how the per-channel channel SRAM block 530, the staged biasing-register pipeline (Register Biasing 1 and Register Biasing 2), and the staged RF-state register pipeline (Register Level 1 and Register Level 2), all under control of the digital controller 520 and the fast-load control, can provide a flexible framework in which baseline operating conditions are established and calibrated once, while RF state information can be prepared and then atomically applied across many RF channels in a deterministic and low-latency manner.

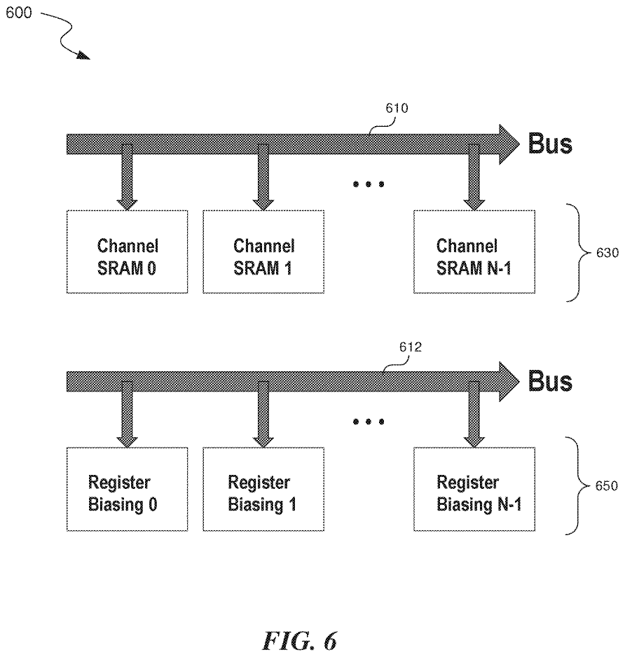

FIG. 6 illustrates an example shared-bus architecture 600 in which a routing bus 610 is coupled to a plurality of channel static random access memory (SRAM) circuits 630 and a routing bus 612 is coupled to a plurality of register-biasing circuits 650. In the example of FIG. 6, the channel SRAM circuits 630 include Channel SRAM 0, Channel SRAM 1, . . . , Channel SRAM N−1, and the register-biasing circuits 650 include Register Biasing 0, Register Biasing 1, . . . , Register Biasing N−1; this organization indicates that each radio-frequency (RF) channel can have an associated channel SRAM circuit and an associated portion of the biasing-register pipeline. The routing bus 610 can convey common address, data, and control signaling that is shared across the channel SRAM circuits 630, and individual ones of the channel SRAM circuits 630 can be selected based on identifier information, channel-select controls, or address decoding so that only a targeted channel SRAM circuit responds to a given transaction. Similarly, the routing bus 612 can convey common address, data, and control signaling that is shared across the register-biasing circuits 650, and identifier or channel-select information can be used so that only selected ones of the register-biasing circuits 650 are updated or read in a particular operation.

In some embodiments, the routing bus 610 forms part of a routing fabric that is coupled to each of the channel SRAM circuits 630, and the routing bus 612 forms part of a routing fabric that is coupled to each of the register-biasing circuits 650. The controller described with respect to FIG. 5 can drive the routing buses 610 and 612 with shared address, data, and control signals, while an identifier field and/or a channel-select control carried on the buses determines which particular channel SRAM circuit and which particular register-biasing circuit respond to a given transaction.

Note that, in some embodiments, a single routing fabric can be implemented as a common bus that is coupled both to the channel SRAM circuits 630 and to the register-biasing circuits 650, so that RF state storage and biasing storage share the same physical address, data, and control conductors while still being distinguishable by address ranges or command encodings. In particular, in some implementations, the channel SRAM circuits 630 and the register-biasing circuits 650 can be mapped to different address ranges within a common address space or are associated with different command encodings, so that transactions targeting RF state storage and transactions targeting biasing storage can be distinguished even though the address, data, and control lines are physically common. In other embodiments, the routing buses 610 and 612 can implement time-division multiplexing uses of a common physical bus, such that during a startup sequence the bus is used to program the register-biasing circuits 650 with baseline biasing information and, during normal operation, the same bus resources are primarily used to access the channel SRAM circuits 630 for RF state updates. Additionally or alternatively, other multiplexing techniques can be applied.

In a number of examples, the controller can operate the routing buses 610 and 612 in either a per-channel mode or a broadcast mode. In the per-channel mode, the controller presents address, data, and control information together with an identifier that selects a single channel SRAM circuit or register-biasing circuit, thereby allowing individual RF channels to be updated or read without disturbing other channels. In the broadcast mode, the controller can present shared address and data values on the routing buses 610 and 612 while asserting a channel-select control that enables a plurality of channel SRAM circuits or register-biasing circuits to capture the values in a single bus operation. For example, a common calibration value or a common biasing setting can be written simultaneously into multiple register-biasing circuits 650, or a default RF state parameter can be programmed into many of the channel SRAM circuits 630 at once. This shared-bus architecture 600 can therefore support efficient programming of both RF state information and biasing information while keeping routing complexity manageable as the number of RF channels scales.

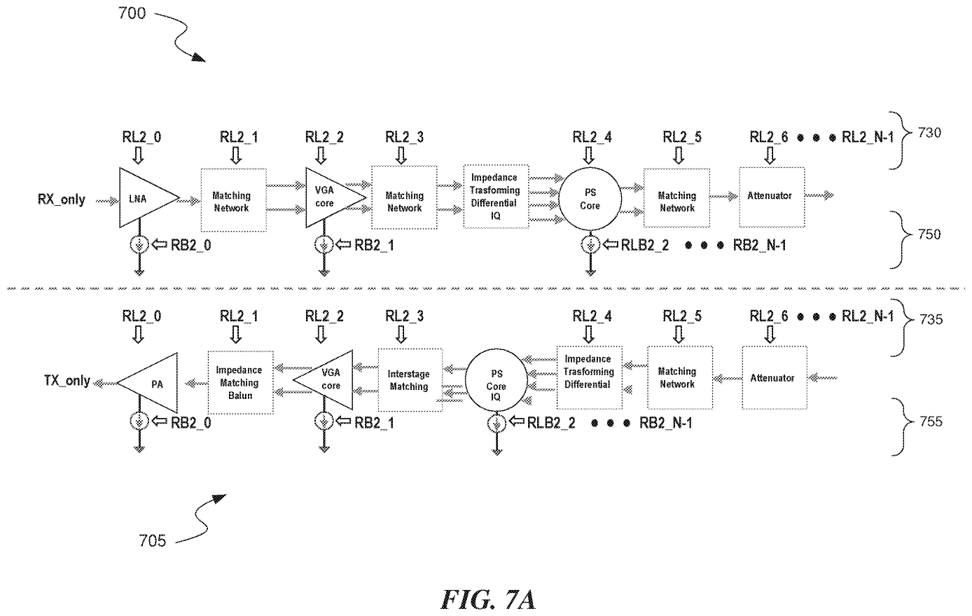

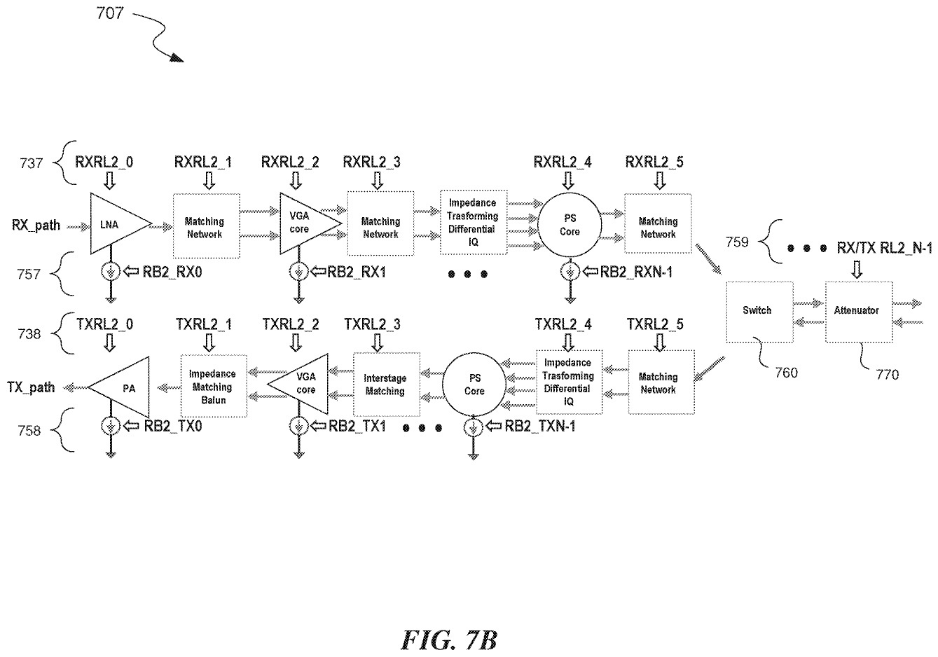

FIG. 7A illustrates an example pair of single-channel radio-frequency (RF) processing paths in an analog beamforming embodiment, including a receive-only RF path 700 and a transmit-only RF path 705, each corresponding to a respective RF channel port. In the illustrated embodiment, the receive-only RF path 700 includes, in cascade, a low-noise amplifier (LNA), a first matching network, a variable-gain amplifier (VGA) core, a second matching network, an impedance-transforming differential in-phase/quadrature (I/Q) block, a phase-shifter (PS) core, a third matching network, and an attenuator. These receive-path functional blocks are driven by RF-state register outputs 730 (e.g., RL2_0, RL2_1, RL2_2, . . . , RL2_N−1 along the receive chain) and RF-biasing register outputs 750 (e.g., RB2_0, RB2_1, RB2_2, . . . , RB2_N−1 along the receive chain). The transmit-only RF path 705 includes, in cascade, a power amplifier (PA), an impedance-matching or matching-network block, a VGA core, an interface-matching block, the phase-shifter core, an impedance-transforming differential I/Q block, a further matching network, and an attenuator. The transmit-path functional blocks are driven by RF-state register outputs 735 (e.g., RL2_0, RL2_1, RL2_2, . . . , RL2_N−1 along the transmit chain) and RF-biasing register outputs 755 (e.g., RB2_0, RB2_1, RB2_2, . . . , RB2_N−1 along the transmit chain), with an example phase-shifter-specific biasing output shown as RLB2_2 in the figure.

During start-up configuration, baseline biasing information that has been committed into the second-stage RF-biasing register block (RB2 in FIG. 5) is applied to the receive-only RF path 700 and the transmit-only RF path 705 via the RF-biasing register outputs 750 and 755, respectively. For example, the RF-biasing register outputs RB2_0, RB2_1, RB2_2, . . . , RB2_N−1 in the receive-path group 750 can provide bias currents, bias voltages, and enable controls to the LNA, the VGA core, the phase-shifter core, and other receive (RX) circuitry. Similarly, the RF-biasing register outputs RB2_0, RB2_1, RB2_2, . . . , RB2_N−1 in the transmit-path group 755 can provide corresponding bias controls to the PA, the VGA core, the phase-shifter core, and other transmit (TX) circuitry. In some embodiments, the RF-biasing register outputs 750 and 755 can further establish and/or store per-channel calibration parameters that compensate channel-to-channel variation so that the N channels are aligned to a common start-up operating condition before RF-state-dependent adjustments are applied.

After the start-up operating condition is established by the RF-biasing register outputs 750 and 755, RF-state information that has been committed into the second-stage RF-state register block (RL2 in FIG. 5) can be applied to provide incremental per-block adjustments. As depicted in FIG. 7A, the RF-state register outputs in group 730 (e.g., RL2_0 through RL2_N−1 along the receive path 700) and the RF-state register outputs in group 735 (e.g., RL2_0 through RL2_N−1 along the transmit path 705) can be applied to corresponding control inputs of blocks along the two paths. In some embodiments, these RF-state register outputs are derived from RF state entries selected from channel-specific SRAM and can encode per-channel deltas in one or more signal attributes. By way of example, the RF-state register outputs 730 and 735 can set amplitude offsets for the VGA cores and attenuators, phase-shift offsets for the phase-shifter core, gain or impedance-tuning offsets for the matching networks and impedance-transforming blocks, and frequency-related offsets including adjustments that move a matching network's resonance condition. In a number of implementations, each RF state can be independently specified for each channel, so that different channels in a multi-channel system can concurrently use different RL2_# settings while sharing similar baseline biasing from RB2_#.

In operation, a full-duplex analog-beamforming configuration for a given RF channel port can be realized by driving the receive-only RF path 700 and the transmit-only RF path 705 simultaneously for that channel. The RF-biasing register outputs 750 and 755 can provide stable baseline biasing for the receive and transmit chains, while the RF-state register outputs 730 and 735, updated under control of the fast-load mechanism described above, can allow rapid and coordinated adjustment of per-block amplitudes, phases, attenuation levels, and other RF parameters along both paths. In this way, the receive-only RF path 700 and the transmit-only RF path 705 in FIG. 7A show how the staged RF-biasing and RF-state register pipelines map onto concrete receive-only and transmit-only analog circuitry to support calibrated start-up behavior together with fast, fine-grained, and channel-specific reconfiguration suitable for full-duplex analog beamforming.

FIG. 7B illustrates another example single-channel radio-frequency (RF) front end 707 in which separate receive (RX) and transmit (TX) paths share downstream application circuitry in a half-duplex analog beamforming embodiment. An RX path includes, in cascade, a low-noise amplifier (LNA), a matching network, a variable-gain amplifier (VGA) core, another matching network, an impedance-transforming differential in-phase/quadrature (I/Q) block, a phase-shifter (PS) core, and a further matching network. Control inputs of these RX-path functional blocks are driven by a set of RX-dedicated RF-state register outputs 737 (e.g., RXRL2_0, RXRL2_1, . . . , RXRL2_N−1 along the RX path) and by a set of RX-dedicated RF-biasing register outputs 757 (e.g., RB2_RX0, RB2_RX1, . . . , RB2_RXN−1). A corresponding TX path includes, in cascade, a power amplifier (PA), an impedance-matching balun, a VGA core, an interstage-matching block, the phase-shifter core, an impedance-transforming differential I/Q block, and a matching network. Control inputs of the TX-path functional blocks are driven by TX-dedicated RF-state register outputs 738 (e.g., TXRL2_0, TXRL2_1, . . . , TXRL2_N−1) and by TX-dedicated RF-biasing register outputs 758 (e.g., RB2_TX0, RB2_TX1, . . . , RB2_TXN−1). On the downstream side, a TX/RX-common RF-state register group 759 (e.g., RX/TX RL2_0, RX/TX RL2_1, . . . , RX/TX RL2_N−1) controls switching circuitry 760 and a shared attenuator 770, which are representative of application circuitry that is reused between the RX path and the TX path for a given RF channel port.

In a half-duplex operating mode, the RF-biasing register outputs 757 and 758 are independently defined so that RB2_RX# values establish a start-up operating condition for the RX chain and RB2_TX# values establish a start-up operating condition for the TX chain. For example, the RB2_RX# values can set bias currents, bias voltages, and enable controls for the LNA, the VGA core, the PS core, and other RX-path circuitry, while the RB2_TX# values set corresponding bias conditions for the PA, the VGA core, the PS core, and other TX-path circuitry. In some embodiments, the RB2_RX# and RB2_TX# values can further initiate and store per-channel calibration parameters that compensate channel-to-channel variation so that the RX and TX paths for each channel are aligned to respective start-up operating points before RF-state-dependent adjustments are applied. As discussed above with reference to FIG. 5, these RB2_RX# and RB2_TX# values can be derived from baseline biasing and calibration information committed from first-stage RF-biasing registers (RB1) into second-stage RF-biasing registers (RB2).

After the start-up conditions are established by the RF-biasing register outputs 757 and 758, distinct RX and TX RF states are applied via separate RF-state register pipelines. In some embodiments, an RX-specific SRAM RF state is loaded into an RX-specific first-stage RF-state register (RX_RL1) and then committed into the RX-dedicated second-stage RF-state registers RXRL2_0 through RXRL2_N−1 in the group 737. Similarly, a TX-specific SRAM RF state is loaded into a TX-specific first-stage RF-state register (TX_RL1) and then committed into the TX-dedicated second-stage RF-state registers TXRL2_0 through TXRL2_N−1 in the group 738. The RXRL2_# and TXRL2_# values can encode incremental changes, or deltas, in one or more signal attributes relative to the baseline established by RB2_RX# and RB2_TX#. By way of example, the RXRL2_# and TXRL2_# values can set amplitude offsets in the VGA cores and matching-network gain stages, phase-shift offsets in the PS cores, attenuation offsets, and impedance-or frequency-related offsets including adjustments to resonance conditions of the matching networks and impedance-transforming I/Q blocks. In a number of implementations, the SRAM RF state used for RX operation can differ from the SRAM RF state used for TX operation so that receive and transmit beam patterns, gains, or operating bands are independently configurable.

Note that, because RX and TX activity are time-multiplexed in half-duplex operation, the architecture 707 can reuse downstream application circuitry by selectively applying one RF-state register output at a time to the shared blocks. A selection control, such as an RX/TX mode signal and/or a half-duplex timing control, can determine which RF-state register bank is effectively visible at the TX/RX-common RF-state register group 759. During an RX interval, the selection control can cause the TX/RX-common RF-state register group 759 to present a value derived from the RX-dedicated RF-state registers (e.g., RXRL2_N−1) to the switch 760 and the attenuator 770. In comparison, during a TX interval, the TX/RX-common RF-state register group 759 instead can present a value derived from the TX-dedicated RF-state registers (e.g., TXRL2_N−1). In some embodiments, the RX Register Level 1 and RX Register Level 2 structures are implemented as distinct register banks from the TX Register Level 1 and TX Register Level 2 structures, so that one path can be updated while the other path is active, and also so that new RX or TX RF states can be ready for activation at the next half-duplex interval. In this manner, FIG. 7B illustrates how dedicated RX and TX RF-state and RF-biasing registers, together with a TX/RX-common RF-state register group and mode-dependent selection of second-stage outputs, support distinct RX and TX RF states while reusing shared downstream circuitry and ensuring that only the corresponding chain is enabled at a given time in half-duplex analog beamforming.

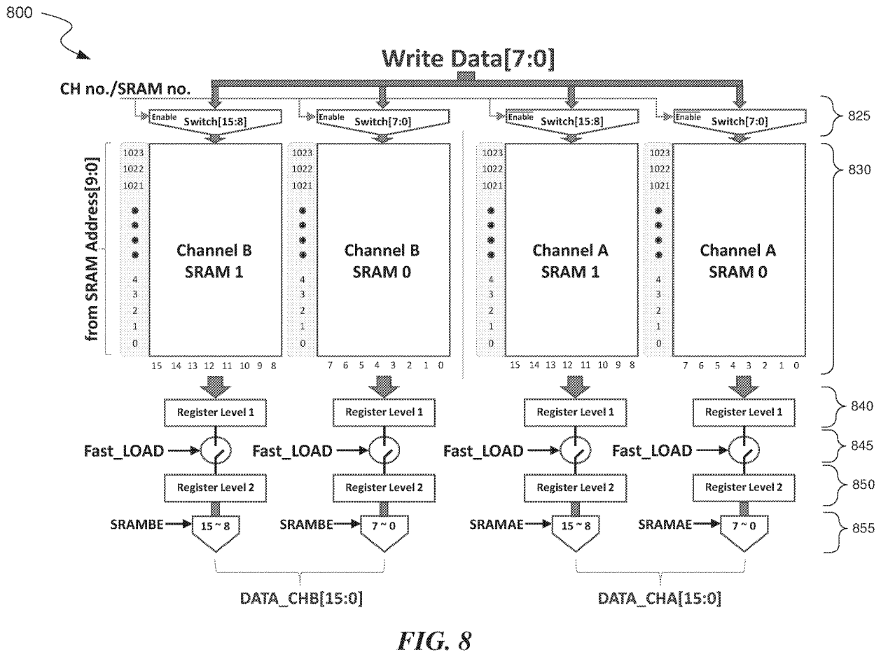

FIG. 8 illustrates an example channel-grouping and register-pipeline architecture 800 in which channel static random access memory (SRAM) structures can be grouped and accessed independently to support full-duplex frequency-division-duplex (FDD) multi-channel operation.

In the illustrated embodiment, channel SRAMs described above are implemented as a channel SRAM block 830 that is structured as 32-bit wide by 1024 rows. The 32-bit width can be partitioned into two 16-bit channel groups (e.g., Channel A and Channel B), and each 16-bit channel group can be further partitioned into two separately addressable 8-bit SRAM slices. Accordingly, the SRAM 830 effectively includes four 8-bit SRAM slices (e.g., Channel A lower-byte [7:0], Channel A upper-byte [15:8], Channel B lower-byte [7:0], and Channel B upper-byte [15:8]), all sharing a common row address but having independently controllable write-enable paths. Note that the 16-bit width and the use of two channel groups (Channel A and Channel B) are examples only; in other embodiments, additional channel-group instances and/or different RF-state word widths can be employed to support more than two RF channels.

A shared write-data bus (Write Data[7:0]) is provided together with channel/SRAM selection information (e.g., CH no./SRAM no.) to access the channel SRAM block 830. In one or more embodiments, the Write Data[7:0] bus carries an 8-bit write-data value, and the channel/SRAM selection information identifies which of the four 8-bit SRAM slices and which byte position within that slice are targeted for a given transfer. Byte-select switches 825 are coupled between the Write Data[7:0] bus and the data-input terminals of the 8-bit SRAM slices in the SRAM 830. By appropriately controlling the channel/SRAM selection information and the enable inputs of the switches 825, a controller can direct the 8-bit write-data value into any selected 8-bit slice at a chosen row address. In this way, 16-bit RF-state words for Channel A and Channel B can be constructed from pairs of 8-bit slices, and the 32-bit-wide SRAM 830 can be written and updated using the narrower 8-bit Write Data[7:0] bus.

In one or more embodiments, each of the 8-bit SRAM slices in the channel SRAM block 830 is coupled to a corresponding 8-bit first-stage RF-state register in a Register Level 1 (RL1) block 840. A tri-state control stage 845 can be provided between the RL1 block 840 and corresponding 8-bit second-stage RF-state registers in a Register Level 2 (RL2) block 850. In some examples, the tri-state control stage 845 is driven by a Fast_LOAD control such that, when Fast_LOAD is asserted, data stored in the RL1 registers 840 for the active bytes are driven through the tri-state stages 845 and captured in the RL2 registers 850 substantially simultaneously.

At the outputs of the RL2 block 850, a switch circuitry block 855 includes four 8-bit switch circuits, each corresponding to a respective 8-bit RL2 segment. The switch circuitry 855 can, e.g., concatenate or route pairs of 8-bit RL2 outputs to form 16-bit channel-level RF-state words for a Channel A group and a Channel B group, thereby generating internal DATA_CHA[15:0] and DATA_CHB[15:0] signals that are applied toward RF processing circuitry for the respective channel groups. As illustrated in FIG. 8, the RL2 outputs can be organized in byte-wide segments that feed channel-level buses such as DATA_CHA[15:0] and DATA_CHB[15:0], with different byte segments corresponding to different bit positions within each 16-bit channel word.

With each logical channel grouping (e.g., Channel A and Channel B), the RL1 registers 840 and the RL2 registers 850 thus can form local RF-state register pipelines whose outputs are presented as 16-bit channel-level RF-state signals for that grouping. In operation, RF-state data words read out of the SRAM 830 for Channel A are first captured in the appropriate RL1 segments of the Channel A pipeline and then transferred into the corresponding RL2 segments responsive to the Fast_LOAD control, after which the RL2 outputs are combined to form DATA_CHA[15:0]. Similarly, RF-state data read for Channel B are staged in RL1, committed into RL2 under Fast_LOAD, and presented as DATA_CHB[15:0].

Furthermore, in full-duplex (e.g., FDD) operation, receive (RX) and transmit (TX) paths associated with channel-grouped RF processing circuits can use different SRAM RF states and separate RF-state register resources to support concurrent operation. For example, RF-state entries associated with a Channel A group can be selected and committed into one set of RL1 and RL2 registers feeding RX-path processing blocks, while RF-state entries associated with a Channel B group are selected and committed into another RL1/RL2 set feeding TX-path processing blocks in a different frequency band. In some embodiments, dedicated RL1 and RL2 banks can be provided for RX and TX paths associated with each group, so that RX-specific SRAM RF states and TX-specific SRAM RF states can be loaded and updated independently while the device operates in a full-duplex FDD mode.

In this manner, the architecture 800 introduced here can therefore provide at least two technical advantages. First, by allowing the 32-bit-wide SRAM block 830 to be partitioned into independently addressable channel groupings, additional logical channel groups can be instantiated without re-architecting the underlying memory array. For example, multiple analog or digital beams can be formed concurrently by assigning different 16-bit (or other-width) groupings within the same SRAM 830 to different beams, so that multi-channel and multi-beam FDD operation is supported while reusing a common physical memory footprint. Second, by using a shared Write Data[7:0] bus and the byte-select switches 825 to feed wider internal SRAM and RF-state register words, the architecture can reduce the number of long global routing lines that would otherwise be needed for a full-width (e.g., 32-bit) external interface. In a number of embodiments, narrowing the shared bus width can lower routing congestion, capacitive loading, and dynamic power on long interconnects, and can simplify floorplanning and timing closure, while still allowing deterministic, coherent RF-state updates via the RL1/RL2 pipelines and the Fast_LOAD mechanism described above.

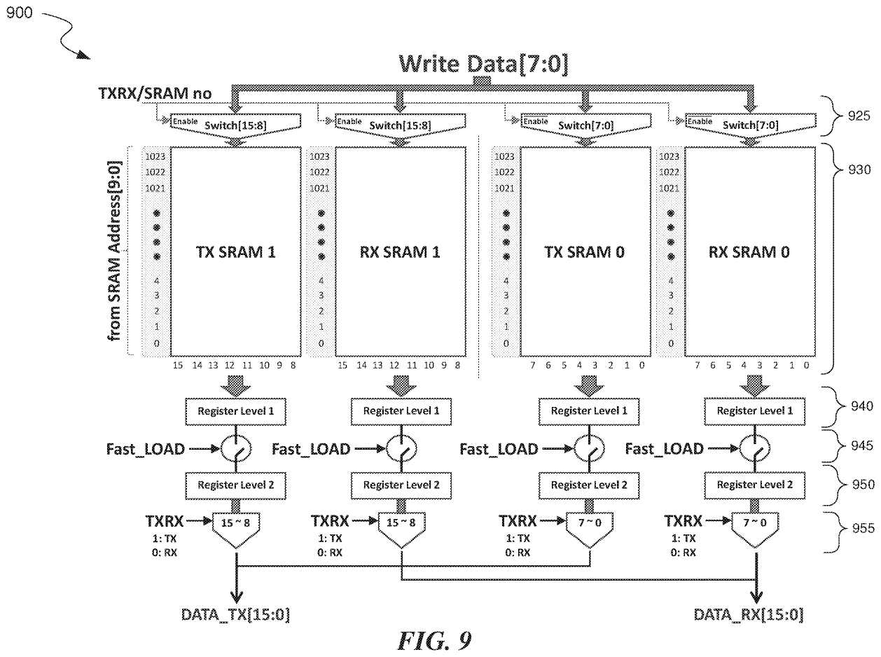

FIG. 9 illustrates an example channel-grouping and register-pipeline architecture 900 in which static random access memory (SRAM) arrays are organized into transmit (TX) and receive (RX) groups in combination with separate transmit-path and receive-path control so as to support half-duplex time-division-duplex (TDD) multi-channel operation.

In the illustrated embodiment, a shared write-data bus Write Data[7:0] is provided together with a TXRX/SRAM selection field (e.g., TXRX/SRAM no.) that indicates which SRAM structure and which byte portion are targeted for a given transfer. A channel SRAM structure 930 includes TX SRAM 1, RX SRAM 1, TX SRAM 0, and RX SRAM 0, which are representative of TX-specific and RX-specific SRAM banks for a given logical channel grouping. Each of the SRAM arrays 930 can be addressed by an address field (e.g., SRAM Address[9:0]) and can store a plurality of RF state entries, such as 16-bit TX or RX RF configuration words arranged as 1024 rows per array.

In one or more embodiments, the write-data bus Write Data[7:0] is coupled, through byte-select switches 925 (e.g., Switch[15:8] and Switch[7:0])), to the data-input terminals of the TX and RX SRAM arrays 930. In a number of implementations, the byte-select switches 925 can determine whether an incoming 8-bit write-data value is written into the upper-byte bits [15:8] or the lower-byte bits [7:0] of a selected 16-bit RF-state word at the addressed location. By appropriately controlling the TXRX/SRAM no. field and the enable inputs of the byte-select switches 925, a controller can direct the Write Data[7:0] value into either a TX-side or an RX-side SRAM and into a selected byte position, so that 16-bit RF state words for TX and RX are constructed from sequences of 8-bit writes over the shared Write Data[7:0] bus.

Beneath each TX SRAM and RX SRAM, the architecture 900 includes a two-stage RF-state register pipeline comprising a first-stage RF-state register block (Register Level 1, or RL1) 940, a tri-state control stage 945, and a second-stage RF-state register block (Register Level 2, or RL2) 950. For a selected RF state entry, the controller can read a 16-bit word from TX SRAM 1, RX SRAM 1, TX SRAM 0, or RX SRAM 0 and load that word into the corresponding RL1 block 940. The tri-state control stage 945 can be driven by a fast-load control signal Fast_LOAD, such that, when Fast_LOAD is asserted, the outputs of the RL1 registers 940 for the active paths are driven through the tri-state stages 945 and captured by the RL2 registers 950 in a substantially simultaneous fashion. In this way, RL1 940 can be updated incrementally while RL2 950 continues to hold the currently applied RF state, and Fast_LOAD can trigger a coordinated update of the active RF-control values seen by downstream circuitry.

On the output side, selector circuits 955 are coupled to the outputs of the RL2 blocks 950. Each selector circuit 955 can present output segments that correspond, e.g., to upper-byte bits [15:8] and lower-byte bits [7:0] of a channel-level data word. A TXRX control value (e.g., logic 1 for transmit and logic 0 for receive) can be applied to each selector circuit 955 and determine whether a TX-side RL2 value or an RX-side RL2 value is forwarded toward the downstream RF processing circuits. In the example of FIG. 9, the selector circuits 955 fed by the RL2 outputs corresponding to TX SRAM 1 and RX SRAM 1 can drive the upper-byte bits DATA[15:8], while the selector circuits 955 fed by the RL2 outputs corresponding to TX SRAM 0 and RX SRAM 0 can drive the lower-byte bits DATA[7:0], so that, under control of the TXRX signal, a complete 16-bit RF control word is assembled from either the TX-side or the RX-side pipeline outputs. For example, when TXRX indicates transmit, the selector circuits 955 can select the TX-side RL2 outputs so that the 16-bit control word appears on DATA_TX[15:0]. Similarly, when TXRX indicates receive, the selector circuits 955 can select the RX-side RL2 outputs so that the 16-bit control word instead appears on DATA_RX[15:0]. Other bit-mapping arrangements can also be implemented depending on system design.

Furthermore, in half-duplex (e.g., TDD) operation, RX and TX paths can use different SRAM RF states that are time-multiplexed into this shared register-pipeline structure. For example, during an RX time interval, the controller can select an RX-specific RF state from an RX SRAM (e.g., RX SRAM 1 or RX SRAM), load the selected RF state into the associated RL1 block 940, and commit that RF state into the RL2 block 950 under control of Fast_LOAD. While TXRX is asserted to indicate RX mode, the selector circuits 955 forward the RX-side RL2 outputs toward the channel-level data buses and onward to the RF processing circuitry. During a subsequent TX time interval, the controller can select a TX-specific RF state from the corresponding TX SRAM (e.g., TX SRAM 1 or TX SRAM 0), load and commit that RF state into the same RL2 block 950, and change the TXRX control such that the selector circuits 955 instead forward the TX-side RL2 outputs. Because RX and TX are not active concurrently in half-duplex operation, the same physical RL1 940 and RL2 950 resources can be reused for both RX and TX roles within a channel grouping, while TX and RX SRAMs maintain separate RF-state libraries that can be tailored to receive and transmit operation.

In this way, the architecture 900 illustrates how SRAM arrays can be grouped into TX and RX logical channels while still taking advantage of a segmented write-data bus, byte-select switching, a fast-load-controlled RL1/RL2 pipeline, and mode-dependent TXRX selection. By using the TXRX/SRAM no. field together with the byte-select switches 925, the controller can write or update RF state entries for TX and RX over the shared Write Data[7:0] bus without dedicating a separate full-width bus per role. By using the TXRX selector circuits 955 at the outputs of the RL2 blocks 950, the controller can present, at different TDD time slots, either RX-derived or TX-derived control words from the same second-stage register outputs to downstream RF processing circuits. This arrangement can enable efficient support for half-duplex multi-channel TDD operation in which RX-specific and TX-specific RF states are maintained in distinct SRAM banks yet applied through shared register-pipeline and bus resources.

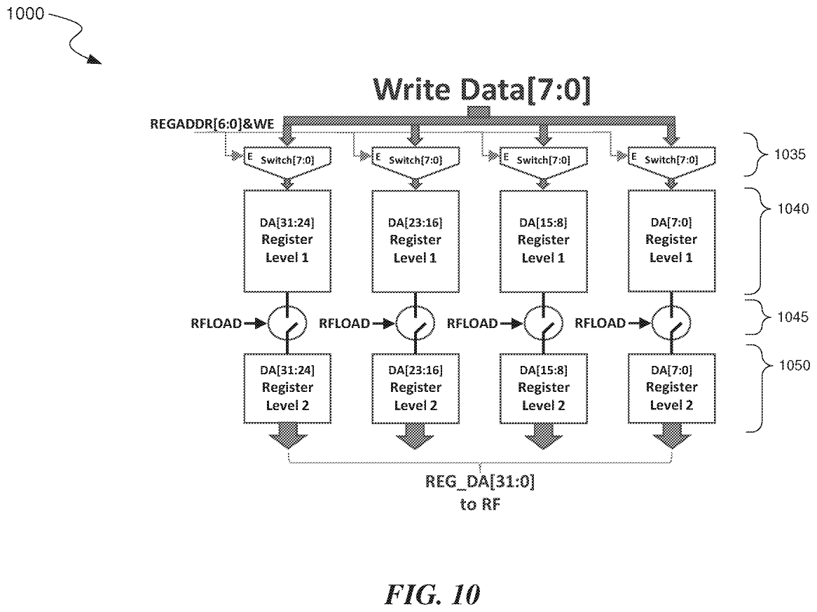

FIG. 10 illustrates an example multi-byte write mechanism 1000 in which a relatively narrow write-data bus is used together with byte-lane switching circuitry to load a wider RF-state register word into first-stage registers. A write-data bus (Write Data[7:0]) can be implemented to carry 8-bit write data under control of a register-address (REGADDR[6:0]) and a write-enable field (WE). As shown in FIG. 10, the Write Data[7:0] bus can be fanned out to a set of byte-lane switches 1035, each of which can selectively couple the 8-bit write-data bus to a different subset of bit positions within a first-stage RF-state register block.

In one or more embodiments, four first-stage registers 1040 are provided, corresponding respectively to bit fields DA[31:24], DA[23:16], DA[15:8], and DA[7:0] of an internal 32-bit word. The byte-lane switches 1035 are controlled based on the REGADDR[6:0] and WE information so that, during a given write cycle, the Write Data[7:0] value is routed into a selected one of the DA[31:24], DA[23:16], DA[15:8], or DA[7:0], of the Register Level 1 blocks. By issuing multiple write cycles with different byte-lane switch enables, a controller can successively load four 8-bit portions of a 32-bit RF-state word into the four first-stage register blocks 1040, so that the full 32-bit register word is assembled in multiple transfers over the 8-bit Write Data[7:0] bus. In this manner, the Register Level 1 stage can be configured to receive write data from a write-data bus whose bit-width is narrower than the bit-width of the internal register word, and the controller is configured to construct a multi-bit RF-state word through multiple byte-wide transfers.

Subsequent to each first-stage register block 1040, a corresponding second-stage register block 1050 (DA[31:24], DA[23:16], DA[15:8], and DA[7:0] of Register Level 2) is provided. A fast-load control signal Fast_LOAD can be applied between the first-stage registers 1040 and the second-stage registers 1050. Specifically, when Fast_LOAD is asserted, the contents of all four first-stage registers 1040 are captured into the corresponding second-stage registers 1050 substantially simultaneously, and the combined 32-bit output word REG_DA[31:0] is presented toward RF circuitry. As a result, the first-stage RF-state registers 1040 can be updated incrementally over multiple 8-bit write cycles without disturbing the currently applied RF state, and the transfer controlled by Fast_LOAD provides an atomic update of the full 32-bit RF-state word at Register Level 2.

In some embodiments, the arrangement of four 8-bit first-stage registers 1040 and four 8-bit second-stage registers 1050 provides a 4×8-bit implementation of the register portion that interfaces to the channel SRAM structures described with respect to FIGS. 8 and 9. It is noted here that providing register write data as an 8-bit field that is expanded to a 32-bit internal word can reduce routing complexity and silicon area relative to routing a full 32-bit bus at the external interface, because the same Write Data[7:0] bus and similar byte-lane switching logic can be reused across many RF channels and RF-state registers. In a number of designs, a 4×8-bit organization can represent a practical engineering compromise between bus width and routing overhead, allowing the system-on-a-chip to maintain substantially the same write timing and operating speed as would be obtained with a dedicated 32-bit external bus, while standardizing internal bus widths and reducing the number of distinct bus variants needed along the RF-state control path.

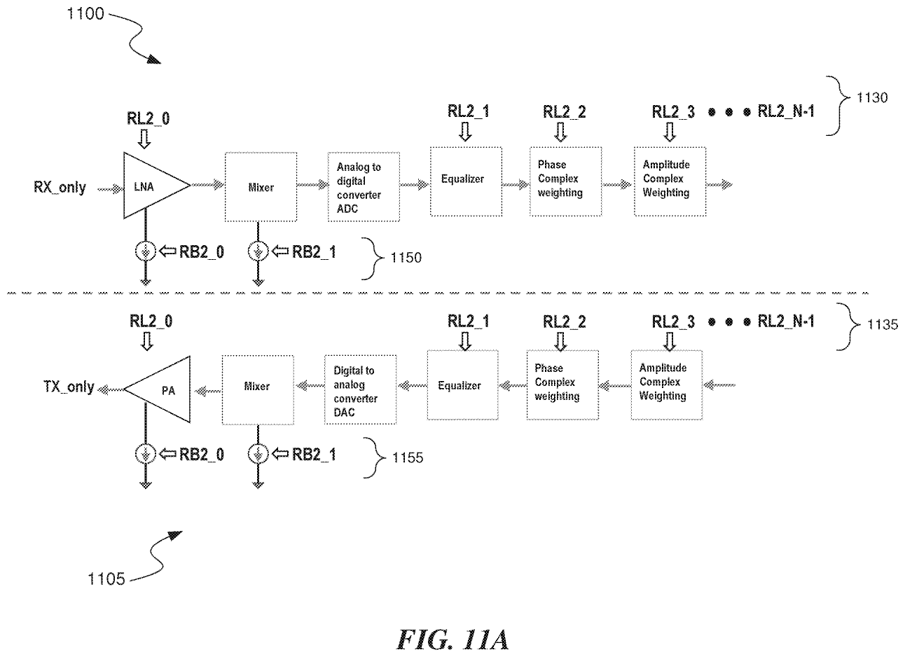

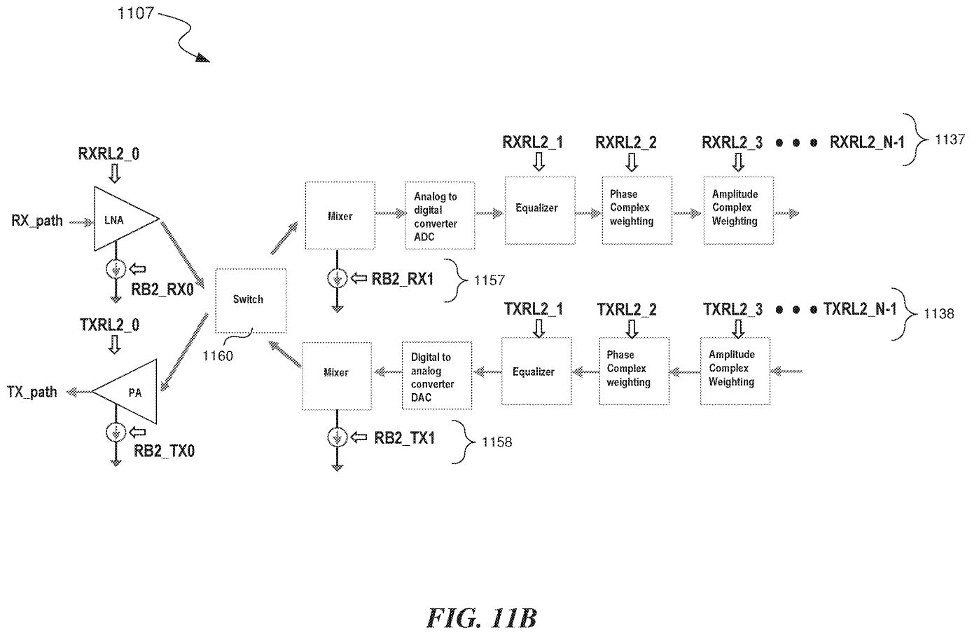

FIG. 11A illustrates example baseband architecture having receive-only and transmit-only processing chains 1100 and 1105 that can be used in full-duplex digital or hybrid beamforming systems. In the receive-only chain 1100, an input signal is processed in sequence by, e.g., a low-noise amplifier (LNA), a mixer that down-converts the signal to an intermediate-frequency or baseband region, an analog-to-digital converter (ADC), an equalizer, a phase complex-weighting block, and an amplitude complex-weighting block. Control inputs for these baseband and mixed-signal functional blocks in the receive-only chain 1100 are driven by a set of RF-state register outputs 1130 (e.g., RL2_0, RL2_1, RL2_2, RL2_3, . . . , RL2_N−1) and by a set of RF-biasing register outputs 1150 (e.g., RB2_0, RB2_1, . . . , RB2_N−1). The transmit-only chain 1105 includes, in sequence, e.g., a power amplifier (PA), a mixer that up-converts a baseband signal, a digital-to-analog converter (DAC), an equalizer, a phase complex-weighting block, and an amplitude complex-weighting block. Corresponding control inputs for the transmit-only chain 1105 are driven by RF-state register outputs 1135 (e.g., RL2_0, RL2_1, . . . , RL2_N−1) and RF-biasing register outputs 1155 (e.g., RB2_0, RB2_1, . . . , RB2_N−1).

During start-up configuration, baseline biasing information that has been committed into the second-stage RF-biasing registers RB2 (e.g., as described with respect to the register-pipeline architecture of earlier figures) is applied to the receive-only chain 1100 and the transmit-only chain 1105 via the RF-biasing register outputs 1150 and 1155. For instance, biasing values RB2_# can set bias currents, bias voltages, and enable controls for the LNA, the PA, the mixers, and the data converters, as well as for other mixed-signal circuitry in the two chains. In some embodiments, these RB2_# values also establish per-channel calibration parameters that compensate channel-to-channel variation, such as gain and noise-figure differences in the LNA or linearity variations in the PA, so that different channels in a multi-channel system are aligned to comparable start-up operating conditions before dynamic RF-state changes are applied.

After the start-up conditions are established by the RB2 outputs, RF-state information that has been committed into the second-stage RF-state registers RL2 is applied to provide incremental digital weighting and tuning for the receive and transmit chains. As depicted in FIG. 11A, the RL2 outputs 1130 for the receive chain and the RL2 outputs 1135 for the transmit chain are derived from RF-state entries selected from channel-specific SRAM and can encode per-channel adjustments for one or more signal attributes. By way of example, RL2_# values can configure equalizer parameters, phase offsets in the phase complex-weighting blocks, and amplitude weights in the amplitude complex-weighting blocks, as well as digital gain or attenuation levels that shape the effective beam pattern or per-subcarrier response in a digital beamforming system. Different RF states can be independently specified for different channels, so that the RL2 settings for each chain can differ across channels while sharing similar baseline biasing from RB2.

In full-duplex operation, the receive-only chain 1100 and the transmit-only chain 1105 for a given channel can be active concurrently, with the RB2 outputs 1150 and 1155 providing stable biasing to the analog and mixed-signal front-end circuitry and the RL2 outputs 1130 and 1135, updated under control of a fast-load mechanism as described previously, providing fast and coordinated adjustments of digital equalization and complex weighting. In this way, FIG. 11A illustrates how the staged RF-biasing and RF-state register pipelines can map onto concrete baseband receive and transmit processing chains to support calibrated start-up behavior and rapid, fine-grained, channel-specific reconfiguration suitable for full-duplex digital or hybrid beamforming.

FIG. 11B illustrates another example baseband architecture 1107 in which a shared RF front end with switching circuitry 1160 feeds separate receive and transmit processing chains that can be used in half-duplex digital or hybrid beamforming systems. On the RF side, an RX path includes, e.g., an LNA biased by RB2_RX0, and a TX path includes a PA biased by RB2_TX0. Outputs of the LNA and PA are coupled to a switch 1160, which selectively routes the active RF signal toward either a receive-side mixer/ADC chain or a transmit-side mixer/DAC chain depending on an RX/TX mode control. The downstream receive-side baseband chain includes, e.g., a mixer, an ADC, an equalizer, a phase complex-weighting block, and an amplitude complex-weighting block, driven by RX-dedicated RF-state register outputs 1137 (e.g., RXRL2_0, RXRL2_1, RXRL2_2, RXRL2_3, . . . , RXRL2_N−1) and RX-dedicated RF-biasing register outputs 1157 (e.g., RB2_RX0, RB2_RX1, . . . , RB2_RXN−1). The upstream transmit-side baseband chain includes, e.g., an amplitude complex-weighting block, a phase complex-weighting block, an equalizer, a DAC and a mixer, driven by TX-dedicated RF-state register outputs 1138 (e.g., TXRL2_0, TXRL2_1, TXRL2_2, TXRL2_3, . . . , TXRL2_N−1) and TX-dedicated RF-biasing register outputs 1158 (for example, RB2_TX0, RB2_TX1, . . . , RB2_TXN−1).

In a half-duplex mode, the RF-biasing register outputs 1157 and 1158 can be defined independently so that RB2_RX# values establish a start-up condition for the receive chain and RB2_TX# values establish a start-up condition for the transmit chain. For example, RB2_RX# can set bias and enable conditions for the LNA, the receive-side mixer, and the ADC, whereas RB2_TX# can set corresponding conditions for the PA, the transmit-side mixer, and the DAC. In some embodiments, these RB2_RX# and RB2_TX# values additionally define calibration parameters that can compensate for, e.g., path-specific gain, linearity, or offset variations, so that the RX and TX paths for each channel are aligned to respective reference operating points prior to applying RF-state-dependent digital weighting. As with earlier figures, the RB2_RX# and RB2_TX# values can be derived from baseline biasing information that was committed from first-stage biasing registers into RB2 during start-up.

After the biasing conditions are set, RX-specific and TX-specific RF states can be applied via separate RF-state register pipelines. In some embodiments, an RX-specific SRAM RF state is loaded into an RX-specific first-stage RF-state register and then committed into the RX-dedicated second-stage RF-state registers RXRL2_0 through RXRL2_N−1 in group 1137, while a TX-specific SRAM RF state is loaded into a TX-specific first-stage RF-state register and committed into the TX-dedicated second-stage RF-state registers TXRL2_0 through TXRL2_N−1 in group 1138. The RXRL2_# and TXRL2_# values can configure, e.g., equalizer coefficients, digital phase offsets, amplitude weights, or other complex-weighting parameters in the respective baseband chains, and the RF states selected for RX can differ from those selected for TX so that receive and transmit beam patterns, gains, or subband responses are independently controllable.

Because RX and TX activity are time-multiplexed in half-duplex operation, the architecture 1107 can reuse the shared RF front end and associated application circuitry by switching both the analog signal path and the effective RF-state control between the RX-dedicated and TX-dedicated register banks. A mode or timing control can govern the switch circuitry 1160 and the selection of RXRL2_# versus TXRL2_# outputs so that, during an RX interval, the receive chain sees the RXRL2_# values and the RB2_RX# biasing conditions, and during a TX interval, the transmit chain instead sees the TXRL2_# values and the RB2_TX# conditions. In this manner, FIG. 11B shows how dedicated RX and TX RF-state and RF-biasing registers, together with a shared front end and mode-dependent selection of second-stage outputs, can support distinct RX and TX RF states for digital or hybrid beamforming while reusing common circuitry and ensuring that only the corresponding path is active at a given half-duplex time slot.

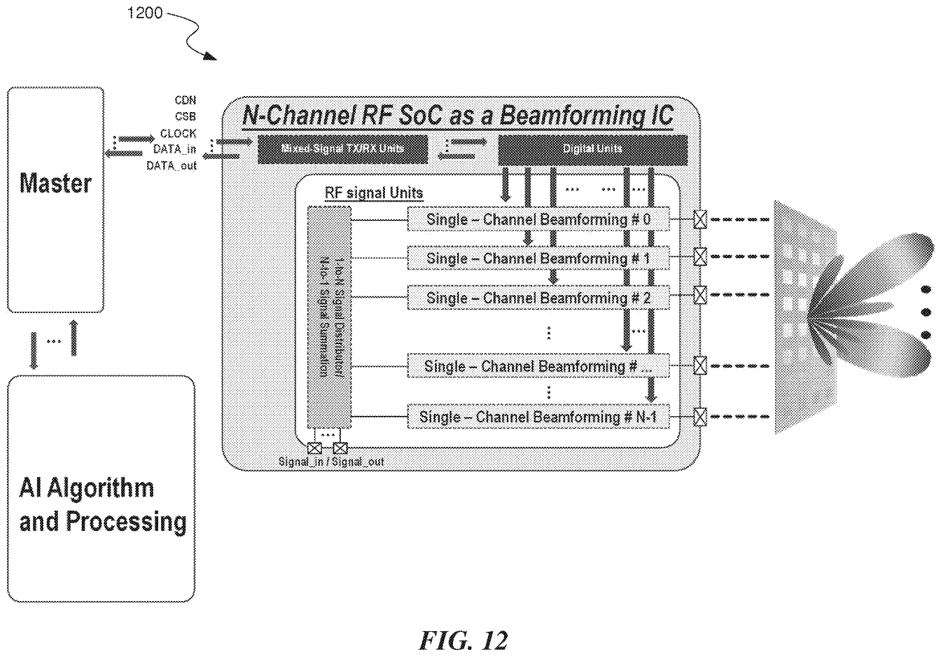

FIG. 12 illustrates an example system 1200 in which a multi-channel radio-frequency (RF) system on a chip (SoC) operates as a beamforming integrated circuit (IC). The beamforming IC is shown as an N-channel RF SoC that includes mixed-signal TX/RX units, digital units, and a bank of RF signal units implementing a plurality of single-channel beamforming chains (e.g., Single-Channel Beamforming #0, #1, #2, . . . , #N−1). A 1-to-N signal distributor and/or an N-to-1 signal summation circuit, similar to that described above for earlier figures, can provide a Signal_in/Signal_out interface between the RF signal units and external circuitry. Each single-channel beamforming chain can be coupled to a corresponding antenna element or to a small antenna sub-array of a larger antenna array, so that the N-channel RF SoC can be deployed in a variety of multi-antenna configurations, including, e.g., multiple-input multiple-output (MIMO) arrays, phased-array panels, and sub-arrayed architectures. In some examples, the system 1200 also can be implemented with one antenna associated with and connected by multiple single-channel beamforming chains for multi-beam operation.

On the control side, a master device is coupled to the N-channel RF SoC over a serial or packetized control interface that carries signals such as a clock (CLOCK), a chip-select (CSB), a reset (CDN), and data streams (for example, DATA_in and DATA_out). The master can transmit configuration commands, RF-state selection information, and other control data to the digital units of the beamforming IC, which in turn configure the mixed-signal TX/RX units and the single-channel beamforming chains. In one or more embodiments, the commands generated by the master cause channel-specific RF states to be retrieved from on-chip SRAM structures and applied, via the staged RF-state and RF-biasing registers described previously, to the corresponding RF signal units. By selecting RF states that encode per-channel phase, amplitude, and other RF parameters, the master can direct the SoC to form, steer, or reshape transmit and/or receive beams toward desired directions, sources, or objects so as to improve link performance and signal quality.

Because the RF states are stored in channel SRAM and applied through the fast-load-controlled register pipelines introduced with earlier figures, the beamforming IC can respond rapidly to RF-state changes. For example, the system can retrieve a per-beam RF state, load it into first-stage RF-state registers for each channel, and then assert a fast-load control so that updated phase and amplitude settings are committed substantially simultaneously across the N channels. This rapid application of RF states can support low-latency beam updates and accurate positioning of receive and/or transmit beams relative to an intended object or region, which can be useful, for instance, when tracking moving users or dynamically switching between different spatial links.

In some embodiments, an AI algorithm and processing component is coupled between the master and the beamforming IC, as depicted in FIG. 12. This AI processing component can execute AI-driven signal-optimization and adaptive-control algorithms that analyze measurements and observations obtained from the RF SoC and/or external sensors, such as received-signal metrics, channel-state information, location or motion estimates, and historical beam-selection outcomes. Based on this analysis, the AI processing component can predict likely signal directions or target locations and can output beam-allocation and RF-state selection guidance to the master with sufficient lead time for beam assignment, transmission, and reception. Such AI-assisted control can be particularly beneficial in highly dynamic environments, including, e.g., autonomous and assisted driving, vehicle-to-everything (V2X) communications, unmanned aerial vehicles and drone swarms, industrial automation, extended-reality (XR) applications, mission-critical communications, high-speed transportation systems, satellite and non-terrestrial networks, healthcare monitoring systems, smart-city infrastructure, and interactive gaming or esports scenarios.

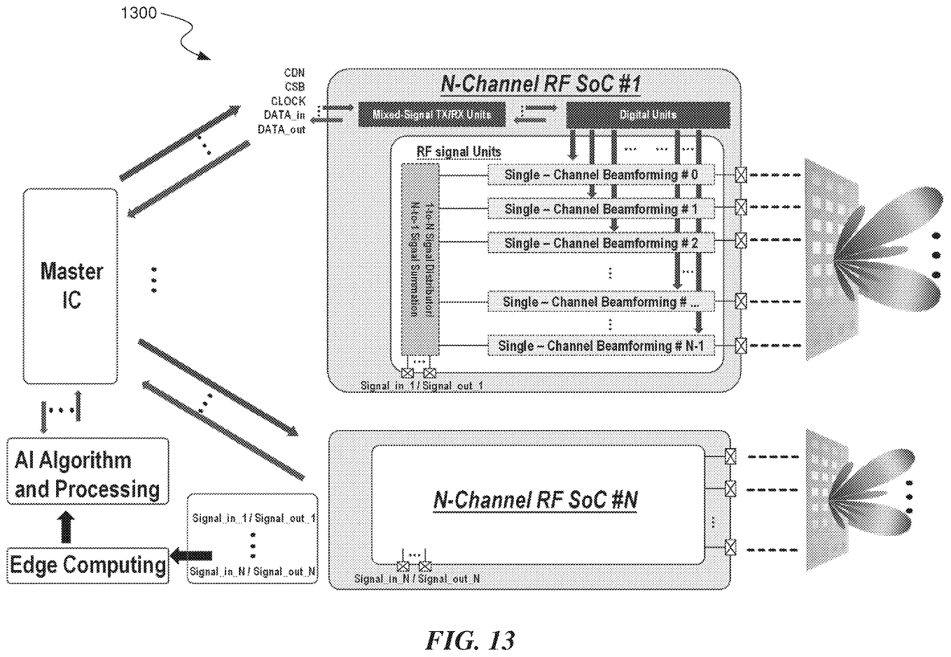

FIG. 13 illustrates an example deployment 1300 including a plurality of N-channel RF SoCs that together form a scalable RF SoC group having multi-mode, multiple-antenna-array processing capability for wireless communication. In the illustrated embodiment, a master integrated circuit (Master IC) is configured to manage and control multiple N-channel RF SoCs concurrently (e.g., N-Channel RF SoC #1 through N-Channel RF SoC #N). Each RF SoC can have the architecture previously described, including mixed-signal TX/RX units, digital units, and a bank of single-channel beamforming chains coupled to a corresponding antenna array. By issuing scheduling, configuration, and RF-state update commands, the Master coordinates operation across the plurality of RF SoCs so that they remain active without interruption during normal operation. The RF SoCs and their antennas can be configured to support a wide range of array topologies and operating modes, including, e.g., advanced phased arrays, sub-arrays, and multiple-input multiple-output (MIMO) configurations, and different array configurations or operating modes can be mixed among channels and/or among RF SoCs to accommodate diverse deployment scenarios.

In some embodiments, an AI algorithm and processing component is integrated with, or coupled to, the Master to provide AI-assisted control across the RF SoC group. The AI processing component can execute learning and optimization algorithms that consume operational data collected from the plurality of RF SoCs, including received-signal metrics, channel-state information, and historical beam-selection outcomes, and can generate guidance for RF-state selection, beam allocation, and timing of state transitions. An edge-computing node is further configured to perform real-time processing locally, without relying on cloud resources, so as to provide low-latency response. As depicted in FIG. 13, each RF SoC exchanges data-path signals SIGNAL_IN_i/SIGNAL_OUT_i with the edge-computing node, where each SIGNAL_IN_i/SIGNAL_OUT_i pair represents one or more data streams that are processed within a corresponding RF SoC and conveyed to or from the wireless domain during receive and transmit operation, respectively.

The edge-computing node can analyze signal data associated with transmission and reception and can determine desired signal formations or beamforming objectives for different RF SoCs and antenna arrays. When a measured signal characteristic deviates from a desired formation, the edge-computing node can generate and transmit commands, hints, or higher-level control objectives to the Master and/or the AI processing component, instructing corrective actions such as updating per-channel phase-and-amplitude weighting, changing RF states, or altering protocol or band selection. In this way, the system can establish an automated feedback mechanism: the edge-computing node collects and organizes information from the plurality of RF SoCs, evaluates performance, and provides adaptive control signals to the AI-assisted Master; in response, the Master issues corresponding configuration and RF-state commands (e.g., DATA_in/DATA_out transfers and register updates) back to one or more RF SoCs. Through this closed-loop interaction among the edge-computing node, the AI-driven Master, and the RF SoC group, the deployment of FIG. 13 can support synchronized low-latency responses, dynamic workload distribution, and improved overall adaptability and performance in highly dynamic wireless environments.

Taken together, FIGS. 12 and 13 illustrate that the disclosed RF-state control architecture scales from a single multi-channel RF SoC acting as a beamforming IC to a coordinated group of such RF SoCs managed by a master device and optional AI and edge-computing resources. In these examples, per-channel RF states stored in SRAM and applied through staged register pipelines can be selected, updated, and synchronized across many channels and many RF SoCs, while the master and AI processing components schedule state transitions, steer beams, and adapt operating modes based on real-time measurements and higher-level objectives. By treating the RF SoCs, antenna arrays, master controller, AI engine, and edge-computing node as parts of a unified control loop, the system can support multi-mode, multi-array, and multi-beam deployments with low-latency feedback, enabling dynamic optimization of beamforming, protocol selection, and resource allocation in diverse and rapidly changing wireless environments.

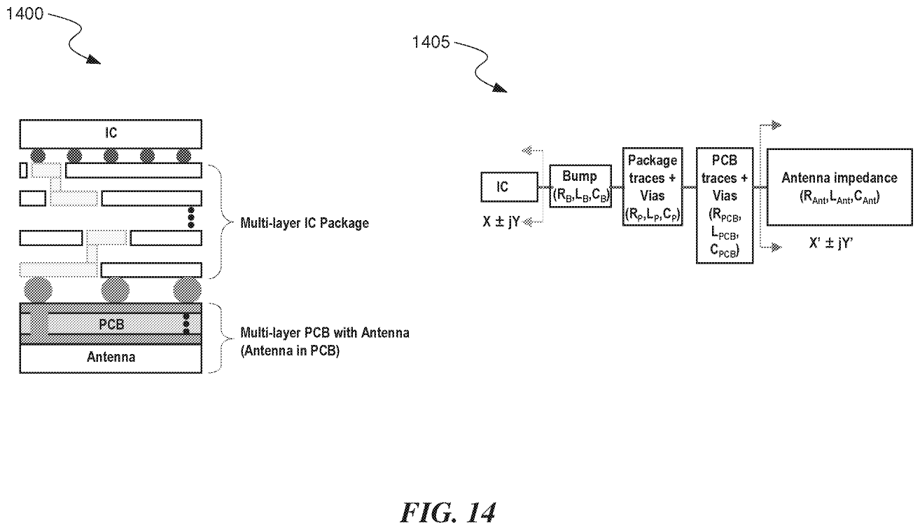

FIG. 14 illustrates an example co-design scenario in which an integrated circuit (IC), such as a system-on-a-chip (SoC) introduced here, is coupled to an antenna formed in a printed-circuit board (PCB). For example, in a phased-array system, the IC can be configured to operate in a transmit mode and/or a receive mode, including by controlling one or more power amplifiers (PAs) and/or one or more low-noise amplifiers (LNAs) associated with respective RF channels. In certain embodiments, the IC is preferably positioned in close physical proximity to an antenna or antenna element in order to reduce interconnect and trace losses between the IC and the antenna. Reducing this loss can improve system-level metrics such as receive sensitivity (e.g., gain-over-noise-temperature, G/T) and delivered transmit power and efficiency, because insertion loss between an LNA and an antenna directly degrades effective receiver noise figure by a similar amount and insertion loss between a PA and an antenna directly reduces delivered transmit power by a similar amount. In some embodiments, the IC can include, or can control, multiple low-noise amplifiers and/or multiple power amplifiers that are respectively associated with different RF channels and/or different polarization paths.

In the cross-sectional view 1400, an IC die can be mounted in a multilayer IC package which, in turn, is mounted on a multilayer PCB that carries an antenna structure (e.g., mounted on the opposite side of the PCB). The signal path from the IC to the antenna can be viewed as a multi-stage interconnect that includes the IC package and the PCB. As shown in the equivalent-network view 1405, starting from the IC, the signal can be routed through a bump or similar package interconnect that exhibits a complex impedance modeled by resistive, inductive, and capacitive components R_B, L_B, and C_B. This bump impedance can be cascaded with package traces and vias having additional resistive, inductive, and capacitive components R_P, L_P, and C_P. The signal can then traverse PCB traces and vias characterized by R_PCB, L_PCB, and C_PCB before reaching the antenna input impedance, which itself can be modeled by resistive, inductive, and capacitive components R_Ant, L_Ant, and C_Ant. In this representation, the antenna can present an impedance X′±jY′, and the cascaded network of bump, package, and PCB structures can collectively transform that antenna impedance into an effective impedance X±jY presented to the IC input or output that satisfies design targets for transmit-mode and/or receive-mode circuitry, such as the LNAs and/or PAs.

This arrangement in FIG. 14 illustrates that the bump, package, PCB, and antenna impedance elements can be co-designed as a distributed co-matching network rather than requiring a conventional 50-ohm match at every intermediate interface. Individual transitions along the path need not be matched to a 50-ohm reference; instead, the overall cascaded network can be configured to provide the desired impedance transformation and/or impedance scaling between the antenna and the IC while also accounting for loss and bandwidth constraints. While reducing physical distance between the IC and the antenna can further reduce loss, tight placement is not mandatory when the cascaded network is engineered to provide suitable impedance transformation and acceptable insertion loss across the operating band.

In some embodiments, the physical realization can utilize antenna-in-package techniques. For example, the IC can be mounted in a flip-chip ball-grid array based antenna-in-package structure, in a hybrid-substrate based antenna-in-package module, and/or in a PCB-based arrangement in which the IC is mounted adjacent to an embedded or printed antenna region. These approaches can shorten RF trace length, reduce parasitic loading, and give the designer additional degrees of freedom to distribute matching elements between the package and the PCB. In further embodiments, the IC can include, or can control, a dual-feeding structure that integrates multiple LNAs and/or multiple PAs within a unit cell so as to support multiple polarization modes. For instance, the dual-feeding structure can support dual linear polarization (e.g., horizontal and vertical), circular polarization, and/or elliptical polarization, in contrast to single-feed PA or LNA architectures. When combined with the co-designed bump, package, PCB, and antenna impedances described above, this dual-feeding structure can enhance polarization agility and overall beamforming performance by enabling impedance transformation and polarization-dependent signal paths to be co-optimized with the antenna and interconnect structures.

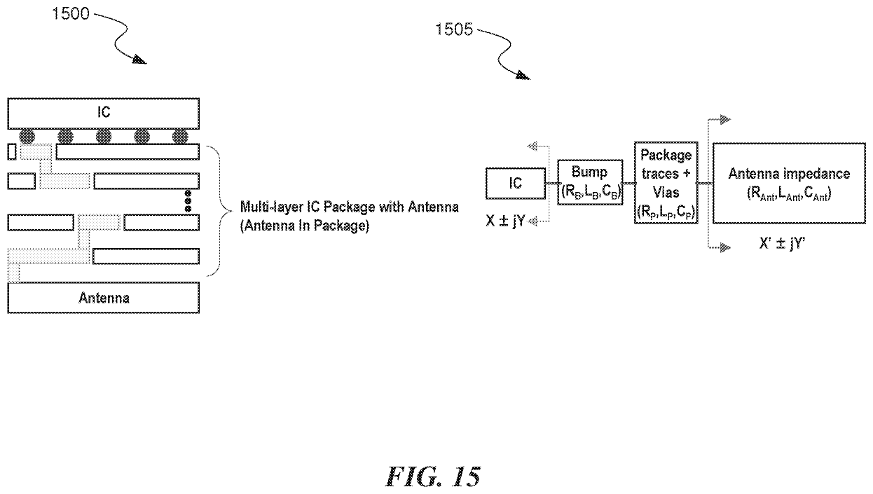

FIG. 15 illustrates another example co-design scenario in which an integrated circuit (IC), such as a system-on-a-chip (SoC) introduced here, is coupled to an antenna implemented in an antenna-in-package (AiP) configuration. In the cross-sectional view 1500, the IC die is mounted in a multilayer IC package that also carries an integrated antenna structure, so that RF signals can travel from the IC through package metallization directly into the antenna region without traversing a separate PCB trace.

In the equivalent-network view 1505, the signal path from the IC to the antenna can be modeled as a cascade of impedance elements. Starting from the IC port (input or output), the signal encounters a bump or similar package interconnect that can be represented by resistive, inductive, and capacitive components R_B, L_B, and C_B. The bump is followed by package traces and vias represented by impedance elements R_P, L_P, and C_P, and these elements in turn connect to an antenna impedance modeled as R_Ant, L_Ant, and C_Ant. Collectively, these elements can form a co-matching network that transforms an antenna impedance X′±jY′ into an effective impedance X±jY at the IC, with the effective impedance tuned to meet design targets for transmit-mode and/or receive-mode circuitry, such as power amplifiers and/or low-noise amplifiers.

The AiP configuration of FIG. 15 demonstrates a technique in which the IC, bump, package traces, and antenna are co-designed as a distributed matching network rather than requiring a discrete 50-ohm match at each adjacent building block. Note that, although reducing physical distance between the IC and the antenna can help minimize loss, it is not strictly necessary, because the cascaded impedance elements can be selected to achieve the desired impedance transformation and impedance scaling while keeping insertion loss within acceptable limits.

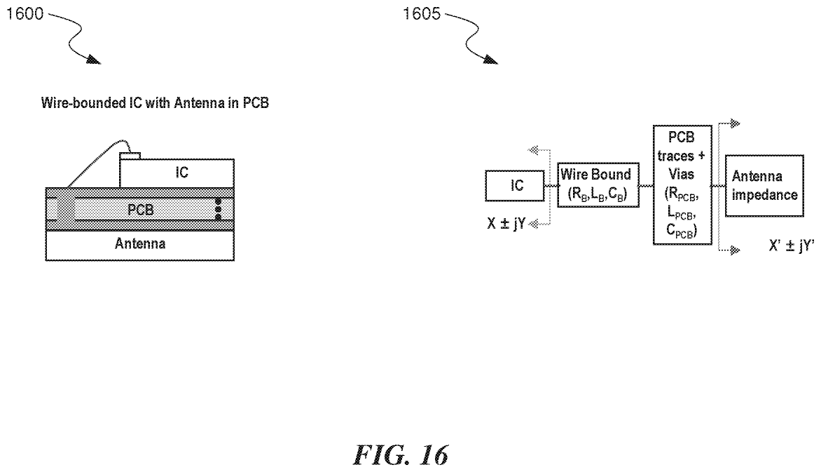

FIG. 16 illustrates still another example co-design scenario in which an integrated circuit (IC), such as a system-on-a-chip (SoC) introduced here, is wire-bonded to a printed-circuit board (PCB) that carries an antenna implemented in the PCB. In the cross-sectional view 1600, the IC is mounted on the PCB and coupled to PCB routing by one or more wire bonds, while the antenna structure is formed within or on the PCB so that the RF path extends from the IC, through the wire bond, along PCB traces and vias, and into the antenna region.

In the equivalent-network view 1605, the signal path from the IC to the antenna can be modeled as a cascade of impedance elements. Starting from the IC, the wire bond is represented by resistive, inductive, and capacitive components R_B, L_B, and C_B. The wire bond feeds PCB traces and vias that are modeled collectively by R_PCB, L_PCB, and C_PCB, which in turn connect to an antenna impedance represented by R_Ant, L_Ant, and C_Ant. Collectively, these elements form a co-matching network that transforms an antenna impedance denoted as X′±jY′ into an effective impedance X±jY presented to the IC, with the effective impedance configured to meet design targets for transmit-mode and/or receive-mode circuitry, such as power amplifiers and/or low-noise amplifiers. Like discussed before, designs utilizing this co-design technique do not require an intermediate 50-ohm match at every interface; instead, the wire-bond, PCB, and antenna impedances can be co-designed so that the overall cascaded network provides the desired impedance transformation and impedance scaling.

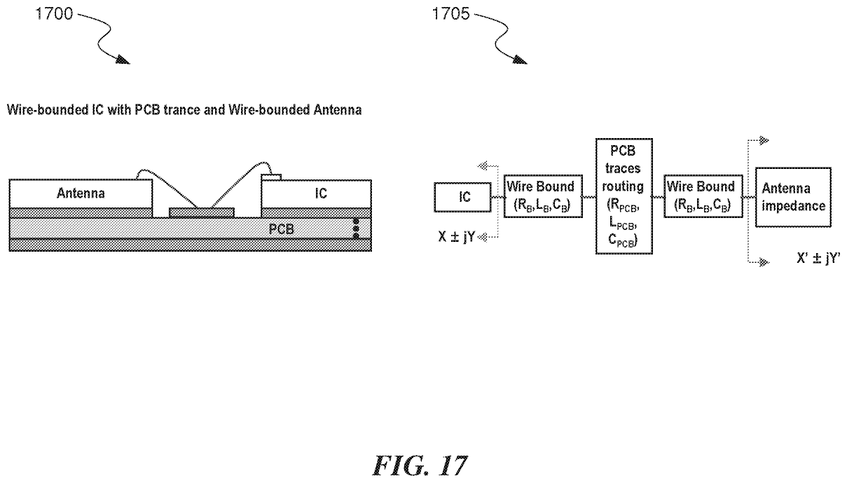

FIG. 17 illustrates yet another co-design scenario in which an integrated circuit (IC), such as a system-on-a-chip (SoC) introduced here, is wire-bonded to a PCB that carries an antenna that is also wire-bonded to the PCB. In the cross-sectional view 1700, a first set of wire bonds connects the IC to PCB routing, and a second set of wire bonds connects the antenna structure back to the PCB routing, so that the RF path includes two wire-bond transitions separated by PCB traces and vias.

In the equivalent-network view 1705, the path from the IC to the antenna is again represented as a cascaded impedance network. Starting at the IC, a first wire bond is modeled by R_B, L_B, and C_B, followed by PCB trace routing and vias modeled by R_PCB, L_PCB, and C_PCB, and then a second wire bond modeled by another set of R_B, L_B, and C_B before reaching the antenna impedance R_Ant, L_Ant, and C_Ant. As in the previous figure, these elements are co-designed as a distributed matching network that transforms the antenna impedance X′±jY′ into an effective impedance X±jY at the IC, without requiring separate 50-ohm matching networks at each adjacent building block. Thus, even when the antenna is wire-bonded at a distance from the IC, the combination of the two wire-bond sections and the PCB routing can be engineered to achieve the required impedance transformation and acceptable insertion loss for transmit-mode and/or receive-mode circuitry, such as the intended PAs and/or LNAs.

Taken together, FIGS. 14-17 illustrate that the bump structures, bond wires, package traces, PCB traces, vias, and antenna impedances can be co-designed as a distributed matching network between an IC and an antenna, regardless of whether the antenna is implemented in the PCB, in an antenna in package structure, or in a wire bonded arrangement. By treating these elements as a cascaded impedance network that transforms an antenna impedance X′±jY′ into an effective impedance X±jY presented to the IC, the designer can avoid imposing a 50-ohm match at every intermediate interface, can place the IC with greater layout flexibility, and can allocate impedance transformation and loss budget across the bump, package, PCB, and antenna structures in a coordinated way. This co-design approach can improve receive sensitivity, delivered transmit power, efficiency, and bandwidth while also supporting advanced features such as multi-polarization antenna configurations and a variety of antenna-in-PCB and antenna-in-package implementations.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims. Further, it should be noted that the various circuits disclosed herein may be described using computer-aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL; formats supporting register-level description languages like RTL; formats supporting geometry description languages such as GDSII, GDSIII, GDSIV, CIF, MEBES; and any other suitable format or language. Computer-readable media in which such formatted data and/or instructions may be embodied include, but are not limited to, non-volatile storage media in various forms (e.g., optical, magnetic, or semiconductor storage media).

What is claimed is:

1. An electronic device comprising:
a plurality of radio frequency (RF) processing circuits corresponding to a plurality of RF channel ports;
a plurality of channel static random access memory (SRAM) circuits, each channel SRAM circuit being associated with a corresponding RF channel port and configured to store one or more RF state entries having control information for the corresponding RF channel port;
an RF-state register pipeline, including a first-stage RF-state register (RL1) and a second-stage RF-state register (RL2), coupled between the plurality of channel SRAM circuits and the plurality of RF processing circuits;
an RF-biasing register pipeline, including a first-stage RF-biasing register (RB1) and a second-stage RF-biasing register (RB2), coupled to the plurality of RF processing circuits; and
a controller configured to: (1) during a startup sequence, commit baseline biasing information in the RB1 to the RB2 so as to apply the baseline biasing information to the plurality of RF processing circuits; and (2) during normal operation:
responsive to a command, access an RF state entry from a given channel SRAM circuit;
load at least a portion of the control information of the accessed RF state entry from the given channel SRAM circuit into the RL1; and
responsive to a fast-load control, commit the control information loaded in the RL1 to the RL2 so as to apply the control information to the corresponding RF processing circuit.

2. The electronic device of claim 1, wherein the baseline biasing information is separate from the control information of the one or more RF state entries.

3. The electronic device of claim 1, wherein the baseline biasing information includes calibration information configured to reduce channel-to-channel variation among the plurality of RF processing circuits.

4. The electronic device of claim 1, wherein the controller is further configured to:
during a startup sequence, load the baseline biasing information from a read-only memory (ROM) into the RB1.

5. The electronic device of claim 1, further comprising:
a routing fabric coupled to the plurality of channel SRAM circuits and to the RF-biasing register pipeline so as to provide access, using shared signaling, to a selected one or more channel SRAM circuits and a selected one or more RF-biasing registers.

6. The electronic device of claim 5, wherein the channel SRAM circuits and the RF-biasing registers occupy different address ranges on the routing fabric or use different command encodings.

7. The electronic device of claim 5,
wherein each channel SRAM circuit is individually addressable on the routing fabric based on an identifier associated with a corresponding RF processing circuit, and
wherein the controller is configured to select a given channel SRAM circuit for access by using the identifier on the routing fabric.

8. The electronic device of claim 5,
wherein RF-biasing registers associated with each RF processing circuit are individually addressable on the routing fabric based on an identifier associated with the corresponding RF processing circuit, and
wherein the controller is configured to select RF-biasing registers for a given RF processing circuit for access by using the identifier on the routing fabric.

9. The electronic device of claim 5,
wherein the routing fabric is configured to transmit address information, data, or control signaling that is shared across the channel SRAM circuits and/or the RF-biasing registers, and
wherein the controller is configured to use an identifier or channel-select control transmitted on the routing fabric to determine which selected ones of the channel SRAM circuits or the RF-biasing registers respond to the address information, the data, or the control signaling.

10. The electronic device of claim 5, wherein the controller is configured to:
program a same control value into a plurality of the channel SRAM circuits or the RF-biasing registers by causing the routing fabric to transmit common address information, data, or control signaling together with a channel identifier or channel-select control that selects the plurality of channel SRAM circuits or the RF-biasing registers.

11. The electronic device of claim 1, wherein the plurality of RF channel ports include at least a first channel group and a second channel group.

12. The electronic device of claim 11, wherein the controller is configured to operate the electronic device in a full-duplex mode by concurrently applying first control information derived from one or more RF state entries to the first channel group and second control information derived from one or more RF state entries to the second channel group.

13. The electronic device of claim 12, wherein the first channel group and the second channel group correspond to frequency-division duplex (FDD) channels.

14. The electronic device of claim 11, wherein the controller is configured to operate the electronic device in a half-duplex mode by:
during a first time interval, applying receive-related control information derived from one or more RF state entries to one of the first channel group or the second channel group; and
during a second time interval, applying transmit-related control information derived from one or more RF state entries to a different one of the first channel group or the second channel group, such that receive-related control information and transmit-related control information are not applied concurrently.

15. The electronic device of claim 14, wherein the first channel group and the second channel group correspond to time-division duplex (TDD) channels, and wherein the controller is configured to:
while the first channel group is operating during the first time interval, load RF state entries for the second channel group from corresponding channel SRAM circuits into the RL1; and
when switching between the first time interval and the second time interval, assert the fast-load control to commit control information loaded in the RL1 to the RL2 so as to apply the control information associated with the second channel group to RF processing circuits associated with the second channel group.

16. The electronic device of claim 11, wherein the controller is configured to operate the electronic device in a multi-beam or multi-signal-processing mode by concurrently applying, to different ones of the channel groups, respective control information derived from one or more RF state entries.

17. The electronic device of claim 16,
wherein the channel groups correspond to different beam directions and/or RF signal-processing channels, and
wherein the plurality of RF processing circuits are configured to generate, based on the respective control information, a corresponding plurality of RF beams or RF signal paths concurrently.

18. The electronic device of claim 1, wherein the fast-load control is provided as a dedicated control signal separate from a data stream used to load the control information into the RL1.

19. The electronic device of claim 1,
wherein the RL1 is configured to receive write data from a write-data bus having a bit-width that is narrower than a bit-width of the RL1, and
wherein the controller is configured to write a multi-bit register word into the RL1 in multiple transfers over the write-data bus.

20. The electronic device of claim 19, wherein the write-data bus includes an 8-bit write-data bus and the RL1 includes a 32-bit register word, the electronic device further comprising:
switch circuitry configured to selectively couple the 8-bit write-data bus to different portions of the 32-bit register word so that the 32-bit register word is written in multiple 8-bit transfers.

21. The electronic device of claim 1,
wherein the command is generated by a master device external to the electronic device, and
wherein the master device is configured to generate or optimize the command based on feedback information representing wireless performance.

22. The electronic device of claim 21, wherein the command is at least in part generated or optimized by an artificial intelligence processing component or an edge-computing device that is coupled between the electronic device and the master device.

23. The electronic device of claim 1,
wherein the device is implemented as an integrated circuit (IC) that is included in an RF system that further includes: one or more antennas; and a matching network coupled between the IC and the one or more antennas,
wherein the matching network is co-designed with an output or input impedance of the IC and with an impedance of the one or more antennas so as to provide a target impedance match over one or more operating bands of the electronic device.
